(19) United States
(12) Patent Application Publication
(10) Pub. No.: US 2026/0215464 A1
(43) Pub. Date: Jul. 30, 2026

(54) A VIBRANT AND STABLE BLUE COLORANT AND METHODS OF MAKING AND USE THEREOF

(71) Applicant: Ohio State Innovation Foundation, Columbus, OH (US)

(72) Inventors: Xinyue FAN, Columbus, OH (US); M. Monica GIUSTI, Columbus, OH (US); Gonzalo MIYAGUSUKU CRUZADO, Mattawan, MI (US)

(21) Appl. No.: 19/147,200

(22) PCT Filed: Jan. 10, 2024
(86) PCT No.: PCT/US2024/010979

§ 371 Date: Jul. 10, 2025

Related U.S. Application Data
(60) Provisional application No. 63/479,464, filed on Jan. 11, 2023.

(51) Int. Cl. A23L 5/44; A23L 2/58; A23L 5/47; C09B 61/00

(52) U.S. Cl. CPC A23L 5/44; A23L 2/58; A23L 5/47; C09B 61/00

(57) ABSTRACT

Disclosed herein are colorant compositions and methods of making and use thereof. For example, disclosed herein are vibrant and stable blue colorants. For example, disclosed herein are colorant compositions comprising: an aluminum salt; an anthocyanidin, an anthocyanin, or a combination thereof; and a caffeoylquinic acid.

### CROSS-REFERENCE TO RELATED APPLICATIONS

This application claims the benefit of priority to U.S. Provisional Application No. 63/479,464 filed Jan. 11, 2023, which is hereby incorporated herein by reference in its entirety.

### BACKGROUND

Color is often used by the consumer as an important indicator of food quality and it may remarkably affect consumer food preferences and acceptance. In recent years, the market for the application of synthetic colorants has decreased in favor of natural colorants, especially since the human safety of synthetic food dyes has been questioned, and their use, legally challenged. For this reason, the food industry is making efforts to replace the synthetic food colorants with naturally-derived colorants.

However, it is challenging to find natural blue colorants to substitute synthetic ones since blue edible materials are rare in nature.

Anthocyanins are a class of flavonoids abundant in plants and they have been associated with health benefits including anti-cancer, anti-inflammation and neuroprotective activities. They can produce blue color in alkaline conditions, but they are seldom used as blue colorants due to their poor stability in these pHs. In addition, most food products are acidic or neutral, so producing a blue colorant for common food applications is still needed.

The compositions, methods, and systems discussed herein addresses these and other needs.

### SUMMARY

In accordance with the purposes of the disclosed compositions, methods, and systems as embodied and broadly described herein, the disclosed subject matter relates to colorant compositions and methods of making and use thereof. For example, disclosed herein are vibrant and stable blue colorants. For example, disclosed herein are colorant compositions comprising: an aluminum salt; an anthocyanidin, an anthocyanin, or a combination thereof, and a caffeoylquinic acid.

For example, disclosed herein are colorant compositions comprising: an aluminum salt; an anthocyanidin, an anthocyanin, or a combination thereof, and a caffeoylquinic acid. In some examples, the colorant is blue at pH 2.9 to 3.3. In some examples, the colorant is edible and/or wherein at least a portion of the composition is an extract of an edible material.

In some examples, the composition is an aqueous composition.

In some examples, the composition is an aqueous composition having a pH from 1-7, from 2-7, from 3-7, from 4-7, from 5-7, from 6-7, from 5-6, from 4-6, from 3-6, from 4-5, from 3-5, or from 3.5-4.5. In some examples, the composition is an aqueous composition having a pH from 2.9 to 5, from 2.9 to 4, or from 3.3 to 4.

In some examples, the aluminum salt is an Al³⁺ salt. In some examples, the aluminum salt is AlCl₃, Al₂(SO₄)₃, aluminum hydroxide, aluminum oleate, aluminum palmitate, aluminum ammonium sulfate, aluminum potassium sulfate, aluminum sodium sulfate, sodium aluminum phosphate, aluminum calcium silicate, sodium aluminosilicate, or a combination thereof. In some examples, the aluminum salt is AlCl₃, Al₂(SO₄)₃, or a combination thereof. In some examples, the aluminum salt is present at a concentration from 0.1-100 mM, from 1-100 mM, from 5-100 mM, from 10-100 mM, from 25-100 mM, from 50-100 mM, from 0.1-10 mM, from 1-10 mM, from 1-5 mM, from 5-10 mM, from 5-25 mM, or from 0.1-2.5 mM.

In some examples, the anthocyanidin or anthocyanin is of Formula I:

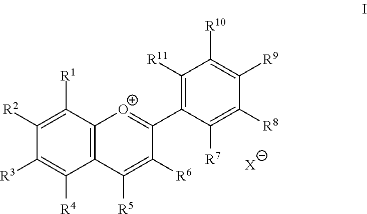

wherein
X is an acceptable anion (e.g., chloride, bromide, iodide, nitrate, sulfate, hydrogen sulfate, phosphate, hydrogen phosphate, dihydrogen phosphate, acetate, etc.);
R¹—R¹¹ are each independently H, OH, OCH₃, or OR^{S}; and
each R^{S} independently is a sugar, an acid, or a combination thereof.

In some examples, each R^{S} independently can be a sugar (e.g., a hexose, a pentose, a deoxyhexose, etc.) optionally with an acid (e.g., hydroxycinnamic acid, aliphatic acids, etc.) attached to said sugar.

In some examples, R^{S} is in each case independently has the formula:

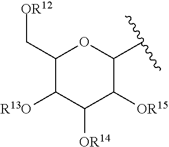

wherein
R¹² is H or monosaccharide;
R¹³ is H or monosaccharide;
R¹⁴ is H or monosaccharide; and
R¹⁵ is H or monosaccharide.

In some examples, the anthocyanidin or anthocyanin is of Formula I:

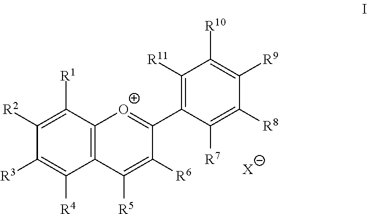

wherein
X is an acceptable anion (e.g., chloride, bromide, iodide, nitrate, sulfate, hydrogen sulfate, phosphate, hydrogen phosphate, dihydrogen phosphate, acetate, etc.);
R¹—R¹¹ are each independently H, OH, OCH₃, or OR^{S}; and
R^{S} is in each case independently has the formula:

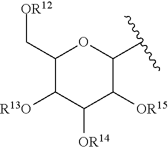

wherein
R¹² is H or monosaccharide;
R¹³ is H or monosaccharide;
R¹⁴ is H or monosaccharide; and
R¹⁵ is H or monosaccharide.

In some examples, the anthocyanidin, the anthocyanin, or a combination thereof comprises a cyanidin, a delphindin, a petunidin, or a combination thereof.

In some examples, the anthocyanidin, the anthocyanin, or a combination thereof comprises delphinidin-3-glucoside, delphinidin-3-rutinoside, delphinidin-3-(p-coumaroylrutinoside)-5-glucoside, petunidin-3-(p-coumaroylrutinoside)-5-glucoside, or a combination thereof.

In some examples, the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof.

In some examples, the caffeoylquinic acid is of Formula III:

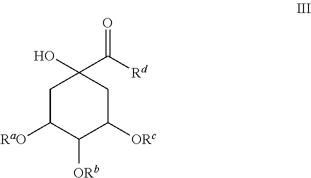

wherein
R^{d} is OH, OC₁₋₄alkyl, or forms bond with one of R^{a}, R^{b}, or R^{C};
R^{a} is H, forms a bond with R^{d}, or has the formula:

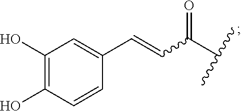 [SMILES: *C(=O)C=Cc1ccc(O)c(O)c1]

R^{b} is H, forms a bond with R^{d}, or has the formula:

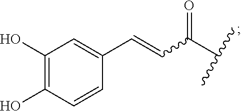 [SMILES: *C(=O)C=Cc1ccc(O)c(O)c1]

R^{c} is H, forms a bond with R^{d}, or has the formula:

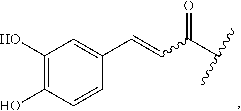 [SMILES: *C(=O)C=Cc1ccc(O)c(O)c1]

provided that at least one of R^{a}, R^{b}, or R^{C} has the formula:

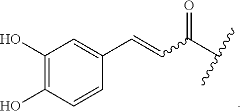 [SMILES: *C(=O)C=Cc1ccc(O)c(O)c1]

In some examples, the caffeoylquinic acid is of Formula III-A:

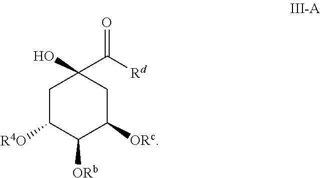

In some examples, the caffeoylquinic acid comprises 5-caffeoylquinic acid, 4-caffeoylquinic acid, 3-caffeoylquinic acid, or a combination thereof. In some examples, the caffeoylquinic acid comprises 5-caffeoylquinic acid.

In some examples, the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof, and the caffeoylquinic acid comprises 5-caffeoylquinic acid.

In some examples, the caffeoylquinic acid comprises 5-caffeoylquinic acid; and the aluminum salt comprises AlCl₃, Al₂(SO₄)₃, or a combination thereof.

In some examples, the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof; the caffeoylquinic acid comprises 5-caffeoylquinic acid; and the aluminum salt comprises AlCl₃, Al₂(SO₄)₃, or a combination thereof.

In some examples, the colorant is edible.

In some examples, the composition is at least partially derived from an edible material.

In some examples, the aluminum salt is food safe.

In some examples, the anthocyanidin, the anthocyanin, or combination thereof is an extract of an edible material. In some examples, the anthocyanidin, the anthocyanin, or combination thereof is an extracted of an eggplant (e.g., American eggplant, Asian eggplant), black goji, or a combination thereof. In some examples, the anthocyanidin, the anthocyanin, or combination thereof is an extract of an eggplant.

In some examples, the caffeoylquinic acid is an extract from an edible material. In some examples, the caffeoylquinic acid is an extract from Yerba Mate.

In some examples, the anthocyanidin, the anthocyanin, or combination thereof is an extract of a first edible material and the caffeoylquinic acid is an extract of a second edible material. In some examples, the anthocyanidin, the anthocyanin, or combination thereof is an extract of an eggplant, black goji, or a combination thereof; and the caffeoylquinic acid is an extract of Yerba Mate. In some examples, the anthocyanidin, the anthocyanin, or combination thereof is an extract of an eggplant; and the caffeoylquinic acid is an extract of Yerba Mate.

In some examples, the colorant has a vibrant and stable blue color at pH from 2.9 to 5. In some examples, the colorant has a vibrant and stable blue color at pH from 2.9 to 3.3. In some examples, the colorant has a vibrant and stable blue color at pH from 3.3 to 4. In some examples, the colorant has a vibrant and stable blue color at pH 3.3. In some examples, the colorant has a vibrant and stable blue color at pH 4.

In some examples, the colorant has a vibrant blue color that is stable for an amount of time of 2 months or more at pH 2.9 to 5 and a temperature of 4° C.

In some examples, the colorant forms a complex similar to the Hydrangea Blue-complex.

In some examples, the colorant comprises a complex of Formula IV:

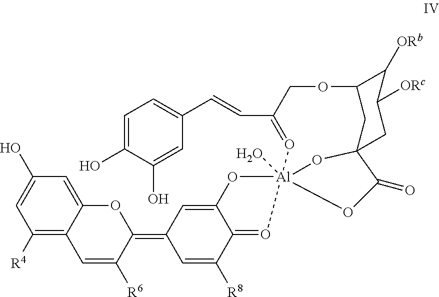

wherein
R⁴ is OR^{S};
R⁶ is OR^{S};
R⁸ is H, OH, or OCH₃;
R^{S} in each case independently has the formula:

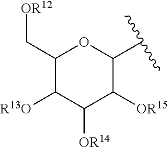

wherein
R¹² is H or monosaccharide;
R¹³ is H or monosaccharide;
R¹⁴ is H or monosaccharide; and
R¹⁵ is H or monosaccharide;
and wherein
R^{b} is H or has the formula:

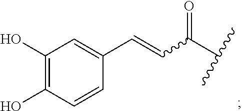 [SMILES: *C(=O)C=Cc1ccc(O)c(O)c1]

R^{c} is H or has the formula:

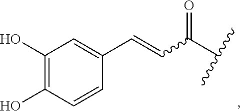 [SMILES: *C(=O)C=Cc1ccc(O)c(O)c1]

or a salt or derivative thereof.

In some examples, the colorant comprises of Formula IV-A:

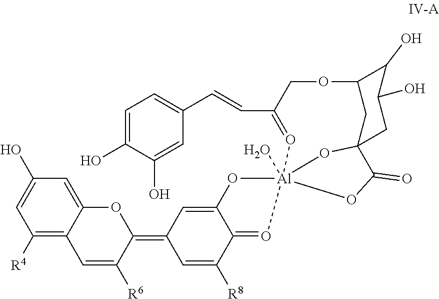

or a salt or derivative thereof.

In some examples, the colorant comprises a complex of Formula V:

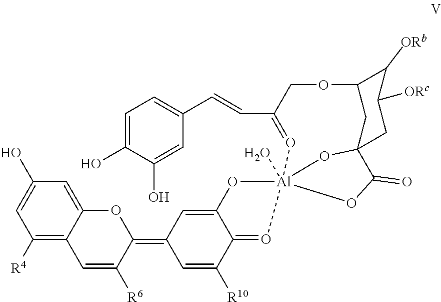

wherein
R⁴ is OR^{S};
R⁶ is OR^{S}; and
R¹⁰ is H, or OH;
R^{S} in each case independently has the formula:

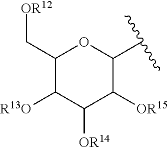

wherein
R¹² is H or monosaccharide;
R¹³ is H or monosaccharide;
R¹⁴ is H or monosaccharide; and
R¹⁵ is H or monosaccharide;
and wherein
R^{b} is H or has the formula:

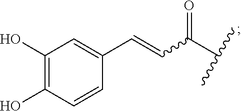 [SMILES: *C(=O)C=Cc1ccc(O)c(O)c1]

R^{c} is H or has the formula:

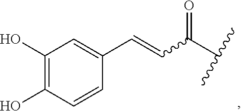 [SMILES: *C(=O)C=Cc1ccc(O)c(O)c1]

or a salt or derivative thereof.

In some examples, the colorant comprises a complex of Formula V-A:

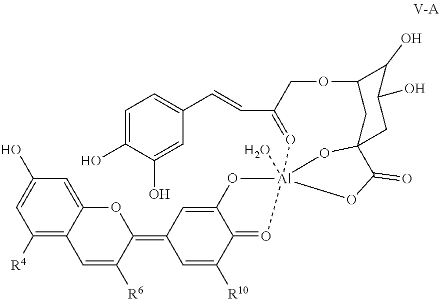

or a salt or derivative thereof.

In some examples, the colorant comprises a complex of Formula VI:

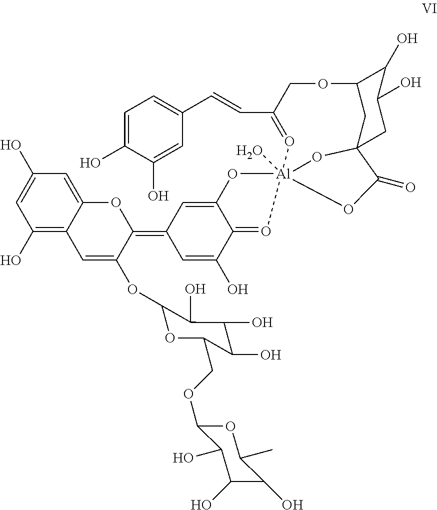

or a salt or derivative thereof.

Also disclosed herein are colorant compositions comprising the extract of an eggplant, the extract of Yerba Mate, and an aluminum salt.

In some examples, the extract of an eggplant is the extract of an eggplant peel. In some examples, the extract of an eggplant is a methanol extract. In some examples, the extract of an eggplant is an acidic methanol extract.

In some examples, the Yerba Mate extract is a hot water extract.

Also disclosed herein are beverages, food products, and/or edible products comprising any of the colorants disclosed herein.

Also disclosed herein are methods of making any of the colorant compositions disclosed herein. In some examples, the method comprises contacting, in any order, the aluminum salt; the anthocyanidin, the anthocyanin, or a combination thereof; and the caffeoylquinic acid; optionally in the presence of a solvent; wherein the method is performed at a pH of 4, to thereby form the colorant composition.

In some examples, the method further comprises subsequently adjusting the pH above or below 4, for example such that the pH is from 2.9 to less than 4 or wherein the pH is from greater than 4 to 5.

In some examples, the method further comprises extracting the anthocyanidin, the anthocyanin, or a combination thereof from an edible material. In some examples, the anthocyanidin, the anthocyanin, or combination thereof is extracted from an eggplant (e.g., American eggplant, Asian eggplant), black goji, or a combination thereof. In some examples, the anthocyanidin, the anthocyanin, or combination thereof is extracted from an eggplant.

In some examples, the method further comprises extracting the caffeoylquinic acid from an edible material. In some examples, the caffeoylquinic acid is extracted from Yerba Mate.

Additional advantages of the disclosed compositions, systems, and methods will be set forth in part in the description which follows, and in part will be obvious from the description. The advantages of the disclosed compositions, systems, and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The accompanying figures, which are incorporated in and constitute a part of this specification, illustrate several aspects of the disclosure, and together with the description, serve to explain the principles of the disclosure.

FIG. 1. Schematic illustration of reproducing the Hydrangea Blue-Complex using edible sources and evaluate their color expression and stability in different pHs, using eggplant peel extract containing delphinidin-derivatives and Yerba Mate containing 5CQA.

FIG. 2A. Absorbance of various components and complex.

FIG. 2B. Color of various components and complex.

FIG. 3. Effect of pH on color.

FIG. 4. Effect of pH on color.

FIG. 5. Color stability vs. pH.

FIG. 6. Color stability vs. pH and over time.

FIG. 7. Circular dichroism results.

FIG. 8. ESI FT-ICR MS results.

FIG. 9. Effect of pH on color and structure.

FIG. 10. Effect of pH on color and structure.

FIG. 11. Color stability over time at 4° C.

FIG. 12. Anthocyanins in eggplant peel.

FIG. 13. Structure of the Hydrangea Blue complex and the proposed structure of the complexation of eggplant anthocyanins and Yerba Mate phenolics.

FIG. 14. Color expression of the new blue complex at different pHs and ratios, compared to the synthetic FD&C Blues.

FIG. 15. Spectra and color (CIELAB) of complexes at different pHs.

FIG. 16A. Spectral changes associated with the blue complex formation. Blue color was only observed when all 3 reactants were present. ACN: anthocyanins, ACN+Al: anthocyanins+Al₂(SO₄)₃; ACN+YMF: anthocyanins+Yerba Mate CQA fraction; ACN+YMF+Al: anthocyanins+Al₂(SO₄)₃+Yerba Mate CQA fraction.

FIG. 16B. Color of various components and complex. Blue color was only observed when all 3 reactants were present. ACN: anthocyanins, ACN+Al: anthocyanins+Al₂(SO₄)₃; ACN+YMF: anthocyanins+Yerba Mate CQA fraction; ACN+YMF+Al: anthocyanins+Al₂(SO₄)₃+Yerba Mate CQA fraction.

FIG. 17. Spectral changes of the blue complex at different pHs.

FIG. 18. Results for acylated black goji complex (A1), American eggplant complex (A2), and Non-acylated black goji complex (A3).

FIG. 19. Results for buffer (left), Waterloo Sparkling Water (C. water, center), and Sprite (right).

FIG. 20. Results for Sprite with additional Al added (100×, as proof of concept).

FIG. 21. Results for complex with higher Al concentration in Yogurt (left) and Sprite (right).

### DETAILED DESCRIPTION

The compositions, methods, and systems described herein may be understood more readily by reference to the following detailed description of specific aspects of the disclosed subject matter and the Examples included therein.

Before the present compositions, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

Values can be expressed herein as an “average” value. “Average” generally refers to the statistical mean value.

By “substantially” is meant within 5%, e.g., within 4%, 3%, 2%, or 1%.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

### Chemical Definitions

Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cn-Cm preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, 1-ethyl-2-methyl-propyl, heptyl, octyl, nonyl, decyl, dodecyl, tetradecyl, hexadecyl, eicosyl, tetracosyl, and the like. Alkyl substituents may be unsubstituted or substituted with one or more chemical moieties. The alkyl group can be substituted with one or more groups including, but not limited to, hydroxyl, halogen, acyl, alkyl, alkoxy, alkenyl, alkynyl, aryl, heteroaryl, aldehyde, amino, cyano, carboxylic acid, ester, ether, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

As used herein, the term “alkenyl” refers to unsaturated, straight-chained, or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Alkenyl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

As used herein, the term “alkynyl” represents straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol, as described below.

As used herein, the term “aryl,” as well as derivative terms such as aryloxy, refers to groups that include a monovalent aromatic carbocyclic group of from 3 to 50 carbon atoms. Aryl groups can include a single ring or multiple condensed rings. In some examples, aryl groups include C₆-C₁₀ aryl groups. Examples of aryl groups include, but are not limited to, benzene, phenyl, biphenyl, naphthyl, tetrahydronaphthyl, phenylcyclopropyl, phenoxybenzene, and indanyl. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is also included in the term “aryl,” defines a group that contains an aromatic group that does not contain a heteroatom. The aryl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems (e.g., monocyclic, bicyclic, tricyclic, polycyclic, etc.) that can be substituted or unsubstituted. A cyclic group can contain one or more aryl groups, one or more non-aryl groups, or one or more aryl groups and one or more non-aryl groups.

The term “acyl” as used herein is represented by the formula —C(O)Z¹ where Z¹ can be a hydrogen, hydroxyl, alkoxy, alkyl, alkenyl, alkynyl, aryl, heteroaryl, cycloalkyl, cycloalkenyl, heterocycloalkyl, or heterocycloalkenyl group described above. As used herein, the term “acyl” can be used interchangeably with “carbonyl.” Throughout this specification “C(O)” or “CO” is a shorthand notation for C═O.

The term “acetal” as used herein is represented by the formula (Z¹Z²)C(═OZ³)(═OZ⁴), where Z¹, Z², Z³, and Z⁴ can be, independently, a hydrogen, halogen, hydroxyl, alkyl, alkenyl, alkynyl, aryl, heteroaryl, cycloalkyl, cycloalkenyl, heterocycloalkyl, or heterocycloalkenyl group described above.

The term “alkanol” as used herein is represented by the formula Z¹OH, where Z¹ can be an alkyl, alkenyl, alkynyl, aryl, heteroaryl, cycloalkyl, cycloalkenyl, heterocycloalkyl, or heterocycloalkenyl group described above.

As used herein, the term “alkoxy” as used herein is an alkyl group bound through a single, terminal ether linkage; that is, an “alkoxy” group can be defined as to a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

The term “aldehyde” as used herein is represented by the formula —C(O)H. Throughout this specification “C(O)” is a shorthand notation for C═O.

The term “amino” as used herein are represented by the formula —NZ¹Z²Z³, where Z¹, Z², and Z³ can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The terms “amide” or “amido” as used herein are represented by the formula —C(O)NZ¹Z², where Z¹ and Z² can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The term “anhydride” as used herein is represented by the formula Z¹C(O)OC(O)Z² where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride” as used herein is represented by the formula:

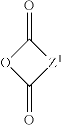

where Z¹ can be an alkyl, alkenyl, alkynyl, aryl, heteroaryl, cycloalkyl, cycloalkenyl, heterocycloalkyl, or heterocycloalkenyl group described above.

The term “azide” as used herein is represented by the formula —N═N═N.

The term “carboxylic acid” as used herein is represented by the formula —C(O)OH.

A “carboxylate” or “carboxyl” group as used herein is represented by the formula —C(O)O⁻.

The term “cyano” as used herein is represented by the formula —CN.

The term “ester” as used herein is represented by the formula —OC(O)Z¹ or —C(O)OZ¹, where Z¹ can be an alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three atom ring and can represented by the formula:

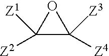

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above.

The term “ketone” as used herein is represented by the formula Z¹C(O)Z², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “phosphonyl” is used herein to refer to the phospho-oxo group represented by the formula —P(O)(OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula —S¹Z¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide” as used herein comprises the formula —S—.

The term “thiol” as used herein is represented by the formula —SH.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amino group, an alkyl group, a halide, and the like. Depending upon the groups that are selected, a first group can be incorporated within a second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

As used herein, Me refers to a methyl group; OMe refers to a methoxy group; and i-Pr refers to an isopropyl group.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

### Colorant Compositions and Method of Making and Use Thereof

Described herein are colorant compositions and methods of making and use thereof. For example, disclosed herein are vibrant and stable blue colorants.

For example, disclosed herein are colorant compositions comprising: an aluminum salt; an anthocyanidin, an anthocyanin, or a combination thereof, and a caffeoylquinic acid.

In some examples, the composition is an aqueous composition.

In some examples, the composition is an aqueous composition having a pH of 1 or more (e.g., 1.5 or more, 2 or more, 2.5 or more, 2.6 or more, 2.7 or more, 2.8 or more, 2.9 or more, 3 or more, 3.1 or more, 3.2 or more, 3.3 or more, 3.4 or more, 3.5 or more, 3.6 or more, 3.7 or more, 3.8 or more, 3.9 or more, 4 or more, 4.1 or more, 4.2 or more, 4.3 or more, 4.4 or more, 4.5 or more, 5 or more, 5.5 or more, 6 or more, or 6.5 or more). In some examples, the composition is an aqueous composition having a pH of 7 or less (e.g., 6.5 or less, 6 or less, 5.5 or less, 5 or less, 4.5 or less, 4.4 or less, 4.3 or less, 4.2 or less, 4.1 or less, 4 or less, 3.9 or less, 3.8 or less, 3.7 or less, 3.6 or less, 3.5 or less, 3.4 or less, 3.3 or less, 3.2 or less, 3.2 or less, 3 or less, 2.9 or less, 2.8 or less, 2.7 or less, 2.6 or less, 2.5 or less, 2 or less, or 1.5 or less). The pH of the aqueous composition can range from any of the minimum values described above to any of the maximum values described above. For example, the composition can be an aqueous composition having a pH of from 1 to 7 (e.g., from 2 to 7, from 3 to 7, from 4 to 7, from 5 to 7, from 6 to 7, from 5 to 6, from 4 to 6, from 3 to 6, from 4 to 5, from 3 to 5, or from 3.5 to 4.5). In some examples, the composition is an aqueous composition having a pH from 2.9 to 5, from 2.9 to 4, from 2.9 to 3.3, or from 3.3 to 4. In some examples, the composition is an aqueous composition having a pH of from 2.9 to 3.3. In some examples, the composition is an aqueous composition having a pH of 3.3.

The aluminum salt can comprise any suitable aluminum salt. In some examples, the aluminum salt is an Al³⁺ salt. In some examples, the aluminum salt is AlCl₃, Al₂(SO₄)₃, aluminum hydroxide, aluminum oleate, aluminum palmitate, aluminum ammonium sulfate, aluminum potassium sulfate, aluminum sodium sulfate, sodium aluminum phosphate, aluminum calcium silicate, sodium aluminosilicate, or a combination thereof. In some examples, the aluminum salt is AlCl₃, Al₂(SO₄)₃, or a combination thereof. In some examples, the aluminum salt is food safe.

In some examples, the aluminum salt is present at a concentration of 0.1 mM or more (e.g., 0.25 mM or more, 0.5 mM or more, 0.75 mM or more, 1 mM or more, 1.25 mM or more, 1.5 mM or more, 2 mM or more, 2.5 mM or more, 3 mM or more, 3.5 mM or more, 4 mM or more, 4.5 mM or more, 5 mM or more, 6 mM or more, 7 mM or more, 8 mM or more, 9 mM or more, 10 mM or more, 15 mM or more, 20 mM or more, 25 mM or more, 30 mM or more, 35 mM or more, 40 mM or more, 45 mM or more, 50 mM or more, 55 mM or more, 60 mM or more, 65 mM or more, 70 mM or more, 75 mM or more, 80 mM or more, 85 mM or more, or 90 mM or more). In some examples, the aluminum salt is present at a concentration of 100 mM or less (e.g., 95 mM or less, 90 mM or less, 85 mM or less, 80 mM or less, 75 mM or less, 70 mM or less, 65 mM or less, 60 mM or less, 55 mM or less, 50 mM or less, 45 mM or less, 40 mM or less, 35 mM or less, 30 mM or less, 25 mM or less, 20 mM or less, 15 mM or less, 10 mM or less, 9 mM or less, 8 mM or less, 7 mM or less, 6 mM or less, 5 mM or less, 4.5 mM or less, 4 mM or less, 3.5 mM or less, 3 mM or less, 2.5 mM or less, 2 mM or less, 1.5 mM or less, 1.25 mM or less, 0.75 mM or less, 0.5 mM or less, or 0.25 mM or less). The concentration of the aluminum salt can range from any of the minimum values described above to any of the maximum values described above. For example, the aluminum salt can be present at a concentration of from 0.1 to 100 mM (e.g., from 1-100 mM, from 5-100 mM, from 10-100 mM, from 25-100 mM, from 50-100 mM, from 0.1-10 mM, from 1-10 mM, from 1-5 mM, from 5-10 mM, from 5-25 mM, or from 0.1-2.5 mM).

The anthocyanidin and/or the anthocyanin can comprise any suitable anthocyanidin and/or anthocyanin.

In some examples, the anthocyanidin or anthocyanin is of Formula I:

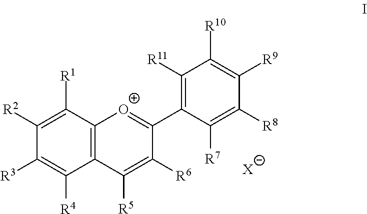

wherein
X is an acceptable anion (e.g., chloride, bromide, iodide, nitrate, sulfate, hydrogen sulfate, phosphate, hydrogen phosphate, dihydrogen phosphate, acetate, etc.);
R¹ is H, OH, OCH₃, or OR^{S};
R² is H, OH, OCH₃, or OR^{S};
R³ is H, OH, OCH₃, or OR^{S};
R⁴ is H, OH, OCH₃, or OR^{S};
R⁵ is H, OH, OCH₃, or OR^{S};
R⁶ is H, OH, OCH₃, or OR^{S};
R⁷ is H, OH, OCH₃, or OR^{S};
R⁸ is H, OH, OCH₃, or OR^{S};
R⁹ is H, OH, OCH₃, or OR^{S};
R¹⁰ is H, OH, OCH₃, or OR^{S};
R¹¹ is H, OH, OCH₃, or OR^{S}; and
each R^{S} independently is a sugar, an acid, or a combination thereof.

In some examples of Formula I, each R^{S} independently can be a sugar (e.g., a hexose, a pentose, a deoxyhexose, etc.) optionally with an acid (e.g., hydroxycinnamic acid, aliphatic acids, etc.) attached to said sugar.

In some examples of Formula I, R^{S} is in each case independently has the formula:

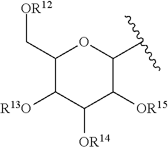

wherein
R¹² is H or monosaccharide;
R¹³ is H or monosaccharide;
R¹⁴ is H or monosaccharide; and
R¹⁵ is H or monosaccharide.

In some examples of Formula I, R⁶ is OR^{S}.

In some examples of Formula I, R⁸ is OH.

In some examples of Formula I, R⁹ is OH.

In some examples of Formula I, R¹⁰ is OH.

In some examples of Formula I, at least one of R⁸ and R¹⁰ is OH.

In some examples of Formula I, R⁸ and R⁹ are each OH.

In some examples of Formula I, R⁹ and R¹⁰ are each OH.

In some examples of Formula I, R⁸, R⁹, and R¹⁰ are each OH.

In some examples of Formula I, R⁷ is H.

In some examples of Formula I, R¹¹ is H.

In some examples of Formula I, R⁷ and R¹¹ are each H.

In some examples of Formula I, R² and R⁴ are each OH.

In some examples of Formula I, R¹ and R³ are each OH.

In some examples of Formula I, R² and R⁴ are each H.

In some examples of Formula I, R¹ and R³ are each H.

In some examples of Formula I, R¹, R³, R⁵, R⁷, and R¹¹ are each H.

In some examples of Formula I, R², R⁴, and R⁹ are each independently OH, OCH₃, or OR^{S}.

In some examples of Formula I, R¹, R³, R⁵, R⁷, and R¹¹ are each H, and R², R⁴, and R⁹ are each independently OH, OCH₃, or OR^{S}.

In some examples, the anthocyanidin or anthocyanin is of Formula II:

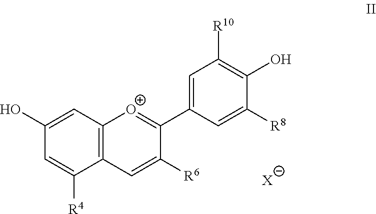

wherein
R⁴ is OR^{S};
R⁶ is OR^{S};
R⁸ is H, OH, or OCH₃; and
R¹⁰ is H, or OH;
R^{S} in each case independently has the formula:

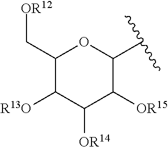

wherein
R¹² is H or monosaccharide;
R¹³ is H or monosaccharide;
R¹⁴ is H or monosaccharide; and
R¹⁵ is H or monosaccharide.

In some examples of Formula I and/or Formula II, each R^{S} independently is:

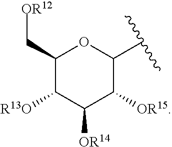

In some examples of Formula I and/or Formula II, R¹³ is H.

In some examples of Formula I and/or Formula II, R¹⁴ is H.

In some examples of Formula I and/or Formula II, R¹⁵ is H.

In some examples of Formula I and/or Formula II, R¹³, R¹⁴, and R¹⁵ are each H.

In some examples of Formula I and/or Formula II, R¹² is H.

In some examples of Formula I and/or Formula II, R¹² has the formula:

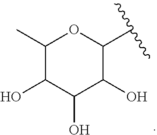 [SMILES: *C1OC(C)C(O)C(O)C1O]

In some examples of Formula I and/or Formula II, R¹² has the formula:

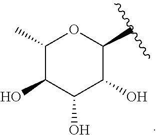 [SMILES: *[C@@H]1O[C@@H](C)[C@H](O)[C@@H](O)[C@H]1O]

In some examples of Formula I and/or Formula II, R^{S} has the formula:

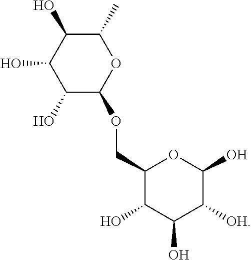 [SMILES: C[C@@H]1O[C@@H](OC[C@H]2O[C@@H](O)[C@H](O)[C@@H](O)[C@@H]2O)[C@H](O)[C@H](O)[C@H]1O]

In some examples of Formula I and/or Formula II, R⁴ is OH or O-glucoside.

In some examples of Formula I and/or Formula II, R⁶ is OH, O-rutinoside, or O-(p-coumaroyl-rutinoside).

In some examples of Formula I and/or Formula II, R⁴ and R⁶ are both OH.

In some examples of Formula I and/or Formula II, R⁴ is OH and R⁶ is O-rutinoside.

In some examples of Formula I and/or Formula II, R⁴ is O-glucoside and R⁶ is O-(p-coumaroyl-rutinoside).

In some examples, the anthocyanidin, the anthocyanin, or a combination thereof comprises a cyanidin, a delphindin, a petunidin, or a combination thereof.

In some examples, the anthocyanidin, the anthocyanin, or a combination thereof comprises delphinidin-3-glucoside, delphinidin-3-rutinoside, delphinidin-3-(p-coumaroylrutinoside)-5-glucoside, petunidin-3-(p-coumaroylrutinoside)-5-glucoside, or a combination thereof. In some examples, the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof.

In some examples, the anthocyanidin, the anthocyanin, or combination thereof is acylated.

In some examples, the anthocyanidin and/or the anthocyanin is present at a concentration of 0.1 mM or more (e.g., 0.25 mM or more, 0.5 mM or more, 0.75 mM or more, 1 mM or more, 1.25 mM or more, 1.5 mM or more, 2 mM or more, 2.5 mM or more, 3 mM or more, 3.5 mM or more, 4 mM or more, 4.5 mM or more, 5 mM or more, 6 mM or more, 7 mM or more, 8 mM or more, 9 mM or more, 10 mM or more, 15 mM or more, 20 mM or more, 25 mM or more, 30 mM or more, 35 mM or more, 40 mM or more, 45 mM or more, 50 mM or more, 55 mM or more, 60 mM or more, 65 mM or more, 70 mM or more, 75 mM or more, 80 mM or more, 85 mM or more, or 90 mM or more). In some examples, the anthocyanidin and/or the anthocyanin is present at a concentration of 100 mM or less (e.g., 95 mM or less, 90 mM or less, 85 mM or less, 80 mM or less, 75 mM or less, 70 mM or less, 65 mM or less, 60 mM or less, 55 mM or less, 50 mM or less, 45 mM or less, 40 mM or less, 35 mM or less, 30 mM or less, 25 mM or less, 20 mM or less, 15 mM or less, 10 mM or less, 9 mM or less, 8 mM or less, 7 mM or less, 6 mM or less, 5 mM or less, 4.5 mM or less, 4 mM or less, 3.5 mM or less, 3 mM or less, 2.5 mM or less, 2 mM or less, 1.5 mM or less, 1.25 mM or less, 0.75 mM or less, 0.5 mM or less, or 0.25 mM or less). The concentration of the anthocyanidin and/or the anthocyanin can range from any of the minimum values described above to any of the maximum values described above. For example, the anthocyanidin and/or the anthocyanin can be present at a concentration of from 0.1 to 100 mM (e.g., from 1-100 mM, from 5-100 mM, from 10-100 mM, from 25-100 mM, from 50-100 mM, from 0.1-10 mM, from 1-10 mM, from 1-5 mM, from 5-10 mM, from 5-25 mM, or from 0.1-2.5 mM).

The caffeoylquinic acid can comprise any suitable caffeoylquinic acid.

In some examples, the caffeoylquinic acid is of Formula III:

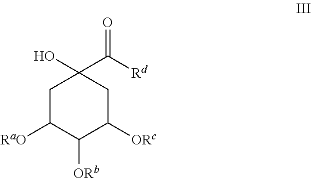

wherein
R^{d} is OH, OC₁₋₄alkyl, or forms bond with one of R^{a}, R^{b}, or R^{C};
R^{a} is H, forms a bond with R^{d}, or has the formula:

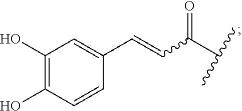 [SMILES: *C(=O)C=Cc1ccc(O)c(O)c1]

R^{b} is H, forms a bond with R^{d}, or has the formula:

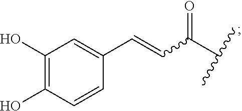 [SMILES: *C(=O)C=Cc1ccc(O)c(O)c1]

R^{c} is H, forms a bond with R^{d}, or has the formula:

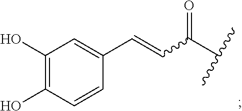 [SMILES: *C(=O)C=Cc1ccc(O)c(O)c1]

provided that at least one of R^{a}, R^{b}, or R^{c} has the formula:

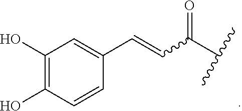 [SMILES: *C(=O)C=Cc1ccc(O)c(O)c1]

In some examples, the caffeoylquinic acid is of Formula III-A:

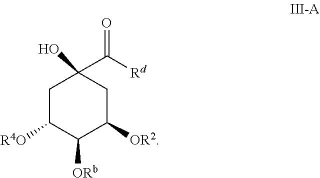

In some examples of Formula III and/or Formula III-A, R^{a} has the formula:

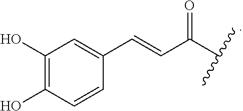 [SMILES: *C(=O)/C=C/c1ccc(O)c(O)c1]

In some examples of Formula III and/or Formula III-A, R^{b} has the formula:

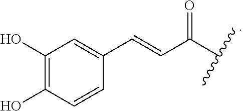 [SMILES: *C(=O)/C=C/c1ccc(O)c(O)c1]

In some examples of Formula III and/or Formula III-A, R^{c} has the formula:

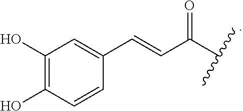 [SMILES: *C(=O)/C=C/c1ccc(O)c(O)c1]

In some examples of Formula III and/or Formula III-A, R^{b} and R^{c} are each H.

In some examples, the caffeoylquinic acid comprises 5-caffeoylquinic acid, 4-caffeoylquinic acid, 3-caffeoylquinic acid, or a combination thereof. In some examples, the caffeoylquinic acid comprises 5-caffeoylquinic acid.

In some examples, the caffeoylquinic acid is present at a concentration of 0.1 mM or more (e.g., 0.25 mM or more, 0.5 mM or more, 0.75 mM or more, 1 mM or more, 1.25 mM or more, 1.5 mM or more, 2 mM or more, 2.5 mM or more, 3 mM or more, 3.5 mM or more, 4 mM or more, 4.5 mM or more, 5 mM or more, 6 mM or more, 7 mM or more, 8 mM or more, 9 mM or more, 10 mM or more, 15 mM or more, 20 mM or more, 25 mM or more, 30 mM or more, 35 mM or more, 40 mM or more, 45 mM or more, 50 mM or more, 55 mM or more, 60 mM or more, 65 mM or more, 70 mM or more, 75 mM or more, 80 mM or more, 85 mM or more, 90 mM or more, 95 mM or more, 100 mM or more, 125 mM or more, 150 mM or more, 175 mM or more, 200 mM or more, 225 mM or more, 250 mM or more, 300 mM or more, 350 mM or more, 400 mM or more, 450 mM or more, 500 mM or more, 600 mM or more, 700 mM or more, 800 mM or more, 900 mM or more, 1000 mM or more, 1250 mM or more, 1500 mM or more, or 1750 mM or more). In some examples, the caffeoylquinic acid is present at a concentration of 2000 mM or less (e.g., 1750 mM or less, 1500 mM or less, 1250 mM or less, 1000 mM or less, 900 mM or less, 800 mM or less, 700 mM or less, 600 mM or less, 500 mM or less, 450 mM or less, 400 mM or less, 350 mM or less, 300 mM or less, 250 mM or less, 225 mM or less, 200 mM or less, 175 mM or less, 150 mM or less, 125 mM or less, 100 mM or less, 95 mM or less, 90 mM or less, 85 mM or less, 80 mM or less, 75 mM or less, 70 mM or less, 65 mM or less, 60 mM or less, 55 mM or less, 50 mM or less, 45 mM or less, 40 mM or less, 35 mM or less, 30 mM or less, 25 mM or less, 20 mM or less, 15 mM or less, 10 mM or less, 9 mM or less, 8 mM or less, 7 mM or less, 6 mM or less, 5 mM or less, 4.5 mM or less, 4 mM or less, 3.5 mM or less, 3 mM or less, 2.5 mM or less, 2 mM or less, 1.5 mM or less, 1.25 mM or less, 0.75 mM or less, 0.5 mM or less, or 0.25 mM or less). The concentration of the caffeoylquinic acid can range from any of the minimum values described above to any of the maximum values described above. For example, the caffeoylquinic acid can be present at a concentration of from 0.1 to 2000 mM (e.g., from 0.1 to 1000 mM, from 1000 to 2000 mM, from 0.1 to 1500 mM, from 0.1 to 500 mM, from 0.1 to 250 mM, from 0.1 to 100 mM, from 0.1 to 50 mM, from 0.1 to 25 mM, from 1 to 2000 mM, from 10 to 2000 mM, from 25 to 2000 mM, from 50 to 2000 mM, from 50 to 2000 mM, from 100 to 2000 mM, from 250 to 2000 mM, from 500 to 2000 mM, from 1 to 1750 mM, or from 5 to 1500 mM).

In some examples, the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof, and the caffeoylquinic acid comprises 5-caffeoylquinic acid.

In some examples, the caffeoylquinic acid comprises 5-caffeoylquinic acid; and the aluminum salt comprises AlCl₃, Al₂(SO₄)₃, or a combination thereof.

In some examples, the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof; the caffeoylquinic acid comprises 5-caffeoylquinic acid; and the aluminum salt comprises AlCl₃, Al₂(SO₄)₃, or a combination thereof.

In some examples, the anthocyanidin and/or anthocyanin and the aluminum of the aluminum salt are present in a ratio of 1:1 or more (anthocyanidin and/or anthocyanin: aluminum, based on molarity) (e.g., 1:2 or more, 1:3 or more, 1:4 or more, 1:5 or more, 1:6 or more, 1:7 or more, 1:8 or more, 1:9 or more, 1:10 or more, 1:15 or more, 1:20 or more, 1:25 or more, 1:30 or more, 1:35 or more, 1:40 or more, 1:45 or more, 1:50 or more, 1:55 or more, 1:60 or more, 1:65 or more, 1:70 or more, 1:75 or more, 1:80 or more, 1:85 or more, or 1:90 or more).

In some examples, the anthocyanidin and/or anthocyanin and the aluminum of the aluminum salt are present in a ratio of 1:100 or less (anthocyanidin and/or anthocyanin:aluminum, based on molarity) (e.g., 1:95 or less, 1:90 or less, 1:85 or less, 1:80 or less, 1:75 or less, 1:70 or less, 1:65 or less, 1:60 or less, 1:55 or less, 1:50 or less, 1:45 or less, 1:40 or less, 1:35 or less, 1:30 or less, 1:25 or less, 1:20 or less, 1:15 or less, 1:10 or less, 1:9 or less, 1:8 or less, 1:7 or less, 1:6 or less, 1:5 or less, 1:4 or less, 1:3 or less, or 1:2 or less). The ratio of anthocyanidin and/or anthocyanin to the aluminum of the aluminum salt can range from any of the minimum values described above to any of the maximum values described above. For example, the anthocyanidin and/or anthocyanin and the aluminum of the aluminum salt are present in a ratio of from 1:1 to 1:100 (anthocyanidin and/or anthocyanin:aluminum, based on molarity) (e.g., from 1:1 to 1:50, from 1:50 to 1:100, from 1:1 to 1:20, from 1:20 to 1:40, from 1:40 to 1:60, from 1:60 to 1:80, from 1:80 to 1:100, from 1:1 to 1:80, from 1:1 to 1:60, from 1:1 to 1:40, from 1:1 to 1:10, from 1:5 to 1:100, from 1:10 to 1:100, from 1:20 to 1:100, from 1:40 to 1:100, from 1:60 to 1:100, or from 1:5 to 1:95).

In some examples, the anthocyanidin and/or anthocyanin and the caffeoylquinic acid are present in a ratio of 1:1 or more (anthocyanidin and/or anthocyanin:caffeoylquinic acid, based on molarity) (e.g., 1:2 or more, 1:3 or more, 1:4 or more, 1:5 or more, 1:6 or more, 1:7 or more, 1:8 or more, 1:9 or more, 1:10 or more, 1:11 or more, 1:12 or more, 1:13 or more, 1:14 or more, 1:15 or more, 1:16 or more, 1:17 or more, or 1:18 or more). In some examples, the anthocyanidin and/or anthocyanin and the caffeoylquinic acid are present in a ratio of 1:20 or less (anthocyanidin and/or anthocyanin:caffeoylquinic acid, based on molarity) (e.g., 1:19 or less, 1:18 or less, 1:17 or less, 1:16 or less, 1:15 or less, 1:14 or less, 1:13 or less, 1:12 or less, 1:11 or less, 1:10 or less, 1:9 or less, 1:8 or less, 1:7 or less, 1:6 or less, 1:5 or less, 1:4 or less, 1:3 or less, or 1:2 or less). The ratio of the anthocyanidin and/or anthocyanin and the caffeoylquinic acid can range from any of the minimum values described above to any of the maximum values described above. For example, the anthocyanidin and/or anthocyanin and the caffeoylquinic acid can be present in a ratio of from 1:1 to 1:20 (anthocyanidin and/or anthocyanin:caffeoylquinic acid, based on molarity) (e.g., from 1:1 to 1:10, from 1:10 to 1:20, from 1:1 to 1:5, form 1:5 to 1:10, from 1:10 to 1:15, from 1:15 to 1:20, from 1:1 to 1:15, from 1:5 to 1:20, from 1:2 to 1:19, or from 1:5 to 1:15).

In some examples, the anthocyanidin and/or anthocyanin, the aluminum of the aluminum salt, and the caffeoylquinic acid are present in a ratio of from 1:1:1 to 1:100:20 (anthocyanidin and/or anthocyanin:aluminum:caffeoylquinic acid, based on molarity).

In some examples, the colorant forms a complex similar to the Hydrangea Blue-complex.

In some examples, the colorant comprises a complex of Formula IV:

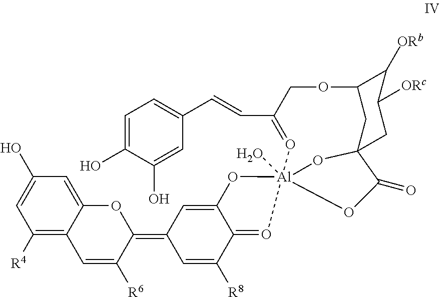

wherein
R⁴ is OR^{S};
R⁶ is OR^{S};
R⁸ is H, OH, or OCH₃;
R^{S} in each case independently has the formula:

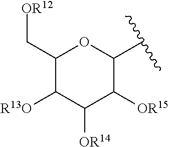

wherein
R¹² is H or monosaccharide;
R¹³ is H or monosaccharide;
R¹⁴ is H or monosaccharide; and
R¹⁵ is H or monosaccharide;
and wherein
R^{b} is H or has the formula:

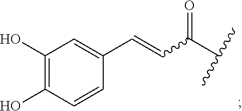 [SMILES: *C(=O)C=Cc1ccc(O)c(O)c1]

R^{c} is H or has the formula:

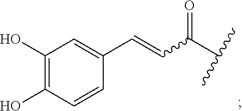 [SMILES: *C(=O)C=Cc1ccc(O)c(O)c1]

or a salt or derivative thereof.

In some examples of Formula IV, the colorant comprises of Formula IV-A:

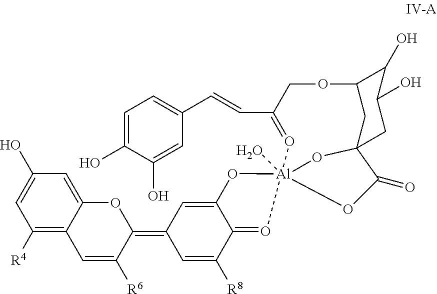

or a salt or derivative thereof.

In some examples, the colorant comprises a complex of Formula V:

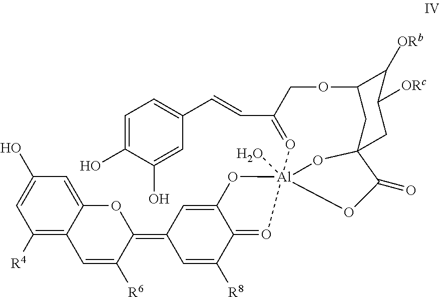

wherein
R⁴ is OR^{S};
R⁶ is OR^{S}; and
R¹⁰ is H, or OH;
R^{S} in each case independently has the formula:

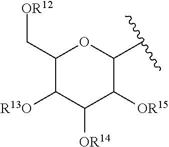

wherein
R¹² is H or monosaccharide;
R¹³ is H or monosaccharide;
R¹⁴ is H or monosaccharide; and
R¹⁵ is H or monosaccharide;
and wherein
R^{b} is H or has the formula:

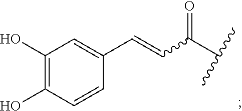 [SMILES: *C(=O)C=Cc1ccc(O)c(O)c1]

R^{c} is H or has the formula:

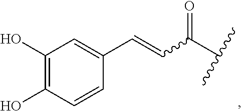 [SMILES: *C(=O)C=Cc1ccc(O)c(O)c1]

or a salt or derivative thereof.

In some examples of Formula V, the colorant comprises a complex of Formula V-A:

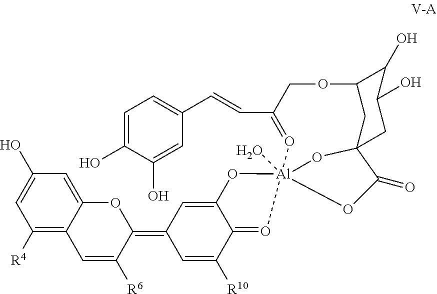

or a salt or derivative thereof.

In some examples, the colorant comprises a complex of Formula VI:

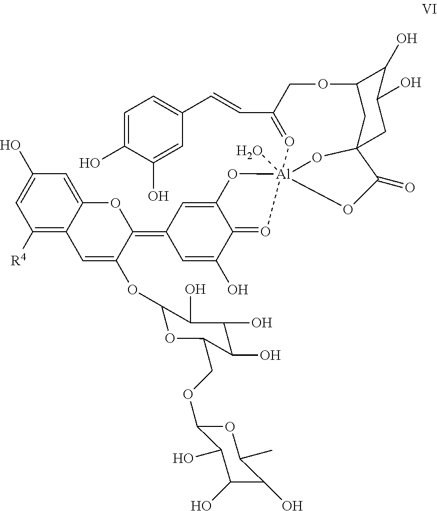

or a salt or derivative thereof.

In some examples, the colorant is edible and/or at least a portion of the composition is an extract of an edible material. In some examples, the colorant is edible. In some examples, the composition is at least partially derived from an edible material. In some examples, the aluminum salt is food safe.

In some examples, the anthocyanidin, the anthocyanin, or combination thereof is an extract of an edible material. For example, the anthocyanidin, the anthocyanin, or combination thereof can comprise a crude extract, a partially purified extract, a purified extract, or a combination thereof.

The anthocyanidin, the anthocyanin, or combination thereof can, for example, be extracted or derived from a whole plant or any portion thereof, such as a flower (e.g., flower petals), leaf, stem, etc. In some examples, the anthocyanidin, the anthocyanin, or combination thereof comprises an extract derived from a raw agricultural product. Examples of raw agricultural products include vegetables, fruits, grains, nuts, and mixtures thereof. In some examples, the raw agricultural product includes a fruit, a vegetable, or a combination thereof.

In some examples, the anthocyanidin, the anthocyanin, or combination thereof comprises an extract derived from a berry such as a bilberry, blueberry, blackberry, blackcurrant, chokeberry, red raspberry, strawberry, elderberry, or a combination thereof. In some examples, the anthocyanidin, the anthocyanin, or combination thereof comprises an extract derived from a red radish (Raphanus sativus), black carrot (Daucus carota L.), red cabbage, black currant, blueberry, red grape, blackberry, red raspberry, choke berry, black goji (Lycium ruthenicum), eggplant (Solanum melongena), American eggplant, Japanese eggplant, Chinese eggplant, East Asian eggplant, tomato (Solanaceae lycopersicum) (cv. Indigo Rose), violet pepper (Capsicum annuum), elderberry, purple potatoes, or a combination thereof.

In some examples, the anthocyanidin, the anthocyanin, or combination thereof is extracted or derived from a berry such as a bilberry, blueberry, blackberry, blackcurrant, chokeberry, red raspberry strawberry, elderberry, or a combination thereof. In some examples, the anthocyanidin, the anthocyanin, or combination thereof is extracted or derived from a red radish (Raphanus sativus), black carrot (Daucus carota L.), red cabbage, black currant, blueberry, red grape, blackberry, red raspberry, chokeberry, black goji (Lycium ruthenicum), eggplant (Solanum melongena), American eggplant, Japanese eggplant, Chinese eggplant, East Asian eggplant, tomato (Solanaceae lycopersicum) (cv. Indigo Rose), violet pepper (Capsicum annuum), elderberry, purple potatoes, or a combination thereof.

In some examples, the anthocyanidin, the anthocyanin, or combination thereof is an extract of an eggplant (e.g., American eggplant, Asian eggplant), black goji, or a combination thereof. In some examples, the anthocyanidin, the anthocyanin, or combination thereof is an extract of an eggplant.

In some examples, the caffeoylquinic acid is an extract from an edible material. In some examples, the caffeoylquinic acid is an extract from Yerba Mate.

In some examples, the anthocyanidin, the anthocyanin, or combination thereof is an extract of a first edible material and the caffeoylquinic acid is an extract of a second edible material. In some examples, the anthocyanidin, the anthocyanin, or combination thereof is an extract of an eggplant, black goji, or a combination thereof; and the caffeoylquinic acid is an extract of Yerba Mate. In some examples, the anthocyanidin, the anthocyanin, or combination thereof is an extract of an eggplant; and the caffeoylquinic acid is an extract of Yerba Mate.

In some examples, the colorant composition comprises the extract of an eggplant, the extract of Yerba Mate, and an aluminum salt. In some examples, the extract of an eggplant is the extract of an eggplant peel. In some examples, the extract of an eggplant is a methanol extract. In some examples, the extract of an eggplant is an acidic methanol extract. In some examples, the Yerba Mate extract is a hot water extract.

Also disclosed herein are colorant compositions comprising the extract of an eggplant, the extract of Yerba Mate, and an aluminum salt. In some examples, the extract of an eggplant is the extract of an eggplant peel. In some examples, the extract of an eggplant is a methanol extract. In some examples, the extract of an eggplant is an acidic methanol extract. In some examples, the Yerba Mate extract is a hot water extract.

In some examples, the colorant has a vibrant and stable blue color.

As used herein a “stable blue color” means that the λₘₐₓ, hue angle, and/or intensity of the blue color change by 50% or less (e.g., 45% or less, 40% or less, 35% or less, 30% or less, 25% or less, 20% or less, 15% or less, 10% or less, 5% or less, or 1% or less) when stored at 4° C. for an amount of time of at least 2 months.

In some examples, the colorant has a vibrant and stable blue color at pH from 2.9 to 5. In some examples, the colorant has a vibrant and stable blue color at pH from 2.9 to 3.3. In some examples, the colorant has a vibrant and stable blue color at pH from 3.3 to 4.

In some examples, the colorant has a vibrant and stable blue color at pH 3.3. In some examples, the colorant is blue at pH from 2.9 to 3.3.

In some examples, the colorant has a vibrant and stable blue color at pH 4.

In some examples, the colorant has a vibrant blue color that is stable for an amount of time of 2 months or more (e.g., 3 months or more, 4 months or more, 5 or more, or 6 months or more) at pH 2.9 to 5 and a temperature of 4° C. In some examples, the colorant has a vibrant blue color that is stable for an amount of time of from 2 to 6 months at pH 2.9 to 5 and a temperature of 4° C.

Also disclosed herein are methods of use of any of the colorant compositions disclosed herein. For example, the colorant compositions can be used as a natural food dye. For example, the colorant compositions can be used in a beverage, a food product, an edible product, or a combination thereof. Also disclosed herein is a beverage comprising any the colorants disclosed herein. Also disclosed herein is a food product comprising any of the colorants disclosed herein. Also disclosed herein is an edible product comprising any of the colorants disclosed herein.

Also disclosed herein are methods of making any of the colorant compositions disclosed herein. For example, the method can comprise contacting, in any order, the aluminum salt; the anthocyanidin, the anthocyanin, or a combination thereof; and the caffeoylquinic acid; optionally in the presence of a solvent; wherein the method is performed at a pH of 4, to thereby form the colorant composition. In some examples, the method further comprises subsequently adjusting the pH above or below 4, for example such that the pH is from 2.9 to less than 4 or wherein the pH is from greater than 4 to 5.

In some examples, the method further comprises extracting the anthocyanidin, the anthocyanin, or a combination thereof from an edible material. In some examples, the anthocyanidin, the anthocyanin, or combination thereof is extracted from an eggplant (e.g., American eggplant, Asian eggplant), black goji, or a combination thereof. In some examples, the anthocyanidin, the anthocyanin, or combination thereof is extracted from an eggplant.

In some examples, the method further comprises extracting the caffeoylquinic acid from an edible material. In some examples, the caffeoylquinic acid is extracted from Yerba Mate A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—A Vibrant and Stable Blue Colorant

Introduction: The food industry is looking for natural colorants with higher stability and versatility. However, blue edible materials are rare in nature, making it challenging to find natural substitutes to synthetic blues. Hydrangea flowers can form a blue complex at pH 4.0 with three components—delphinidin-3-glucoside, 5-caffeoylquinic acid (5CQA), and Al³⁺. American eggplant and Yerba Mate extract were used to reproduce this vibrant, stable anthocyanin-based blue aluminum complex in acidic conditions.

Methods: Anthocyanins (mostly delphinidin-3-rutinoside) were extracted from American eggplant peel with 70% acidified methanol and purified by solid phase extraction (SPE). Methanol was evaporated and anthocyanins were diluted to 3.7 mM (cy-3-glu eq) with 0.01% HCl water. 5CQA was obtained from Yerba Mate hot water extract, fractionated by SPE and freeze dried. Blue complexes were formed in pH 4 buffer by mixing different ratios of eggplant extract, Yerba Mate extract, and AlCl₃ solution (5 mM). HCl was then added to challenge the stability of the complex at lower pH, and stored at 4° C. for 2 months. Spectral data was collected by Microplate Reader within the visible range and converted to colorimetric values expressed by CIEL*C*h.

Results: Complexes were successfully produced at pH 4, and the blue hue remained even when the pH was decreased to 2.90. The λₘₐₓ (586-580 nm) and hue angle (264-266°) did not significantly change when the pH decreased from 4.09 to 3.33. At pH 3.10-2.90, the hue turned to purplish blue (h=273° to 284°). At lower pH the blue color was lost. The colors remained remarkably stable over 2-month storage at 4° C., with no significant change in the λₘₐₓ and >75% blue color retention. Excess 5CQA resulted in lower color stability during storage, while excess delphinidin-3-rutinoside resulted in increased color intensity and absorbance at Amax.

Significance: The blue complexation documented in Hydrangea flowers was replicated using edible materials, providing the food industry with a potential blue colorant for a wider range of pH applications. Using anthocyanin-based colorants also adds value to foods due to their potential health benefits to consumers.

Two-Sentence Description: This study produced a new potential blue colorant for the food industry using readily available edible materials by simulating the Blue-Complex naturally formed in Hydrangea flowers. The blue complex was formed by using eggplant extract, Yerba Mate and aluminum, expressing blue color at pH as low as 2.90 for 2 months refrigerated storage, providing a new natural blue food colorant for the food industry.

### Example 2

A vibrant and stable anthocyanin-based blue colorant from eggplant and Yerba Mate for use in acidic environments is described herein.

This study produced a new potential blue colorant for the food industry using readily available edible materials by simulating the blue complex naturally formed in Hydrangea flowers. The blue complex was formed by using eggplant extract, Yerba mate, and aluminum, expressing blue color at pH as low as 2.9 for 2 months refrigerated storage, providing a new natural blue food colorant for the food industry.

### Example 3—A Vibrant and Stable Anthocyanin-Based Blue Colorant from Eggplant and Yerba Mate for Use in Acidic Environments

Introduction. The food industry is looking for natural colorants with higher stability and versatility. However, blue edible materials are rare in nature, making it challenging to find natural substitutes to synthetic blues. Anthocyanins (ACN) can produce blue color in alkaline conditions, but they are seldom used as blue colorants due to their poor stability in these pHs.

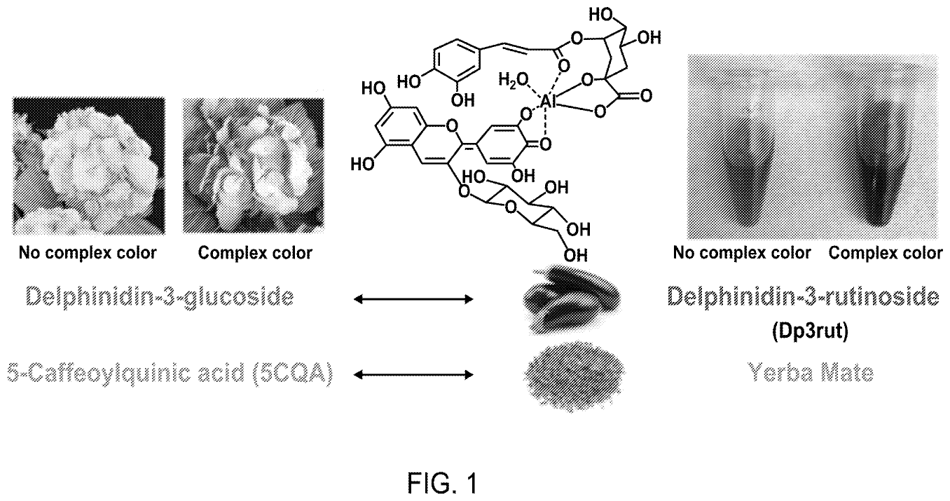

An aim of this study was to reproduce the Hydrangea Blue-Complex using edible sources and evaluate their color expression and stability in different pHs, using eggplant peel extract containing delphinidin-derivatives and Yerba Mate containing 5CQA (FIG. 1).

Methods. Anthocyanins (ACN) from American eggplant peel were extracted and purified. 5CQA was fractionated from Yerba Mate hot water extract (YME) and freeze dried. ACN and 5CQA were combined with Al₂(SO₄)₃ and mixed in a pH 4 buffer for form the complex. The effect of pH on color was investigated by subsequently adjusting the pH to 2.5-7.1 with HCl or NaOH. Color stability was monitored over time by collecting spectra over 31 days for samples stored at 4° C. Color was then calculated (CIE, L*, C_{ab}*, h) from the spectra.

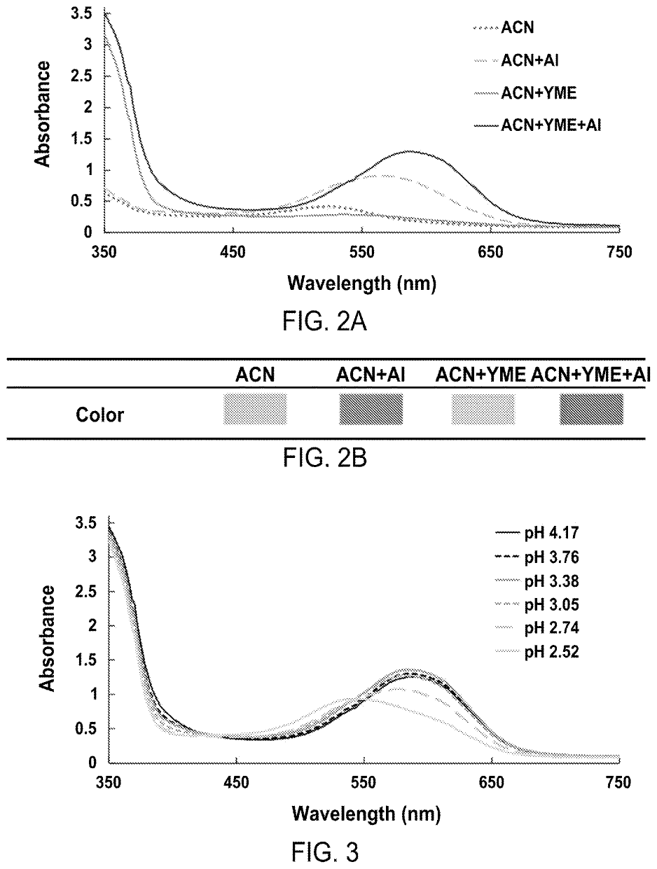

Results. The complex formation results are shown in FIG. 2A-FIG. 2B and Table 1. ACN, YME, and the aluminum salt together produced a blue color, typical of the blue complex (FIG. 2A-FIG. 2B, Table 1).

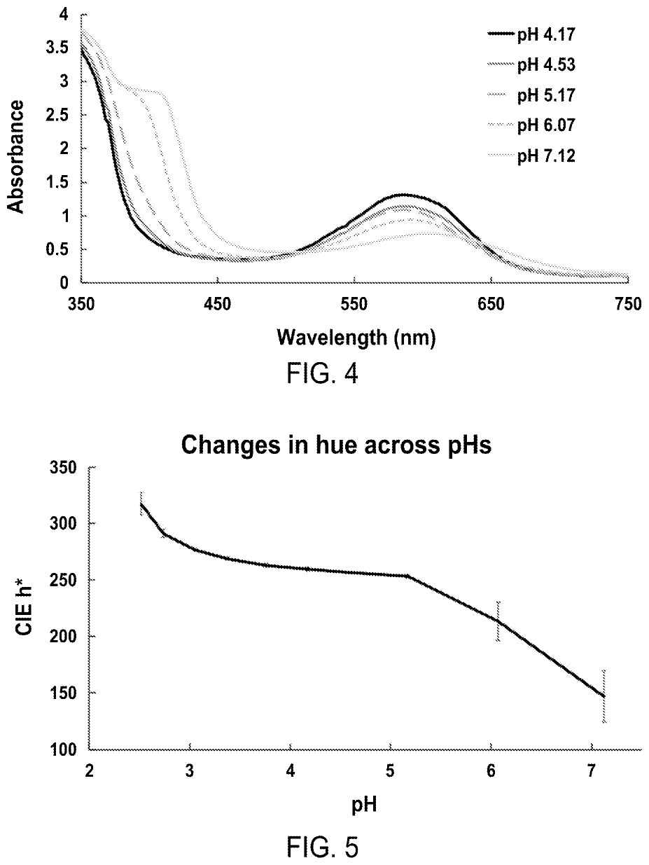

The results for the effect of pH on color are shown in FIG. 3 and FIG. 4. A vibrant blue color was retained between pH 3 and 5. A hypsochromic shift was found when pH was lower than 2.74. A bathochromic shift was found when pH was higher than 6.07.

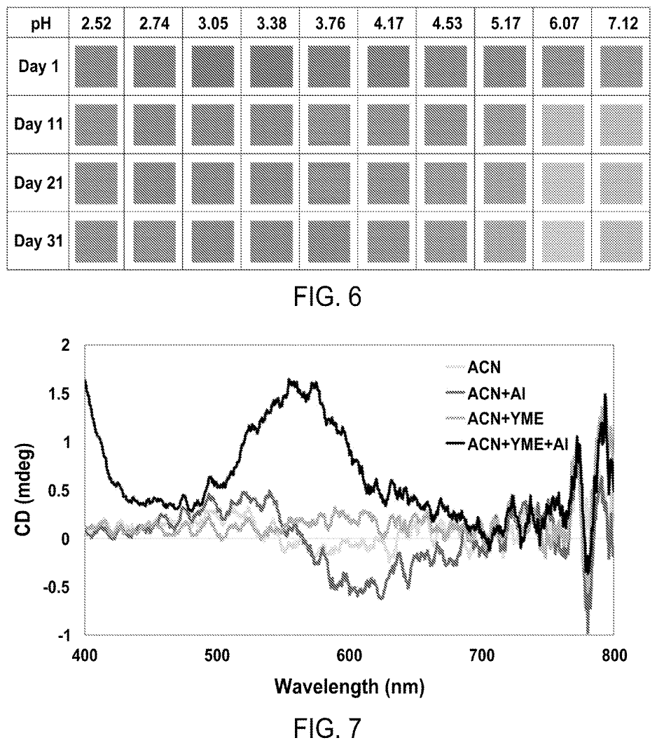

The results of color and stability of pH and time are shown in FIG. 5 and FIG. 6. A blue hue was constantly observed at pH 3-5.

Conclusions. Blue complexes were successfully produced at pH 4 using eggplant ACN, YME and aluminum salt. The blue hue remained when pH was adjusted from 3 to 5. The blue colors remained remarkably stable over 1 month storage at 4° C. at pH 3-4.5. This project provides the food industry with a potential blue colorant for a wider range of pH application.

### Example 4—Structure Elucidation of an Anthocyanin-Based Aluminum Blue Complex and Monitoring the Changes with pH Using Nano Electrospray Ionization FT-ICR Mass Spectrometry

Introduction. The food industry is looking for natural colorants with higher stability and versatility. Blue edible materials are rare in nature, making it extra challenging to find natural substitutes to synthetic blues. Anthocyanins (ACN) can produce blue color in flowers, but blue colors are hard to reproduce in other matrices, and they are seldom used as colorants due to their poor stability.

An aim of this study was to reproduce the Hydrangea Blue-Complex using edible sources and evaluate their color expression and structure in different pHs, using eggplant peel extract containing delphinidin-derivatives and Yerba Mate containing 5CQA (FIG. 1).

Methods. Anthocyanins (ACN) from American eggplant peel were extracted and purified. 5CQA was fractionated from Yerba Mate hot water extract (YME) and freeze dried. ACN and 5CQA were combined with Al₂(SO₄)₃ and mixed in a pH 4 buffer for form the complex. The effect of pH on color was investigated by subsequently adjusting the pH to 2.5-7.1 with HCl or NaOH. Color stability was monitored over time by collecting spectra over 31 days for samples stored at 4° C. Color was then calculated (CIE, L*, C_{ab}*, h) from the spectra.

Circular dichroism was used to identify structural changes across pH.

Nano Electrospray Ionization Fourier Transform Ion Cyclotron Resonance Mass Spectrometry (ESI FT-ICR MS) was used to verify the typical structure of the complex at pH ~4.

Results. The complex formation results are shown in FIG. 2A-FIG. 2B and Table 1. ACN, YME, and the aluminum salt together produced a blue color, typical of the blue complex (FIG. 2A-FIG. 2B, Table 1).

Circular dichroism results are shown in FIG. 7.

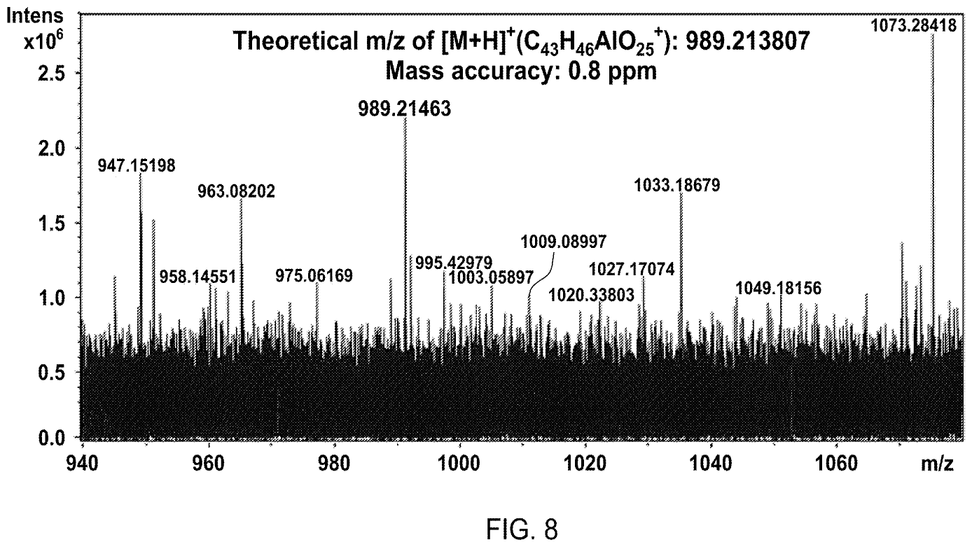

ESI FT-ICR MS results are shown in FIG. 8.

The results for the effect of pH on color are shown in FIG. 3 and FIG. 4. A vibrant blue color was retained between pH 3 and 5. A hypsochromic shift was found when pH was lower than 2.74. A bathochromic shift was found when pH was higher than 6.07.

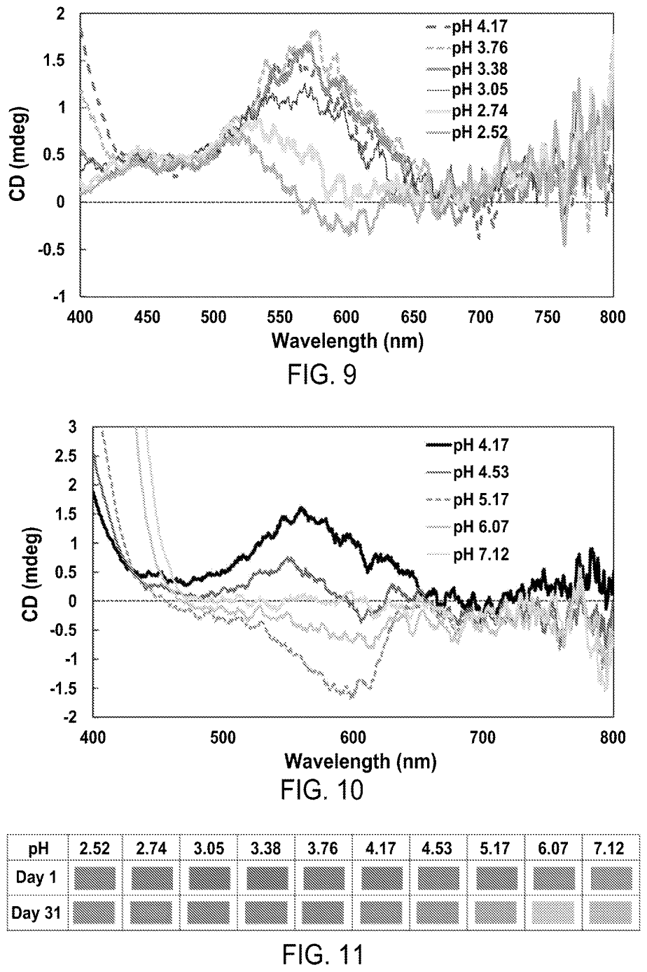

The results for the effect of pH on color and structure are shown in FIG. 9 and FIG. 10. In more acidic pH, the complexes did not break until pH 3.05, below pH 3.05, the complex structure was lost. In low acid/neutral pH, there was less complex in pH 4.5. However, the negative cotton effect suggests the complex structure might change at pH higher than 5.

The results of color and stability of pH and time are shown in FIG. 11. A blue hue remained over one month storage at 4° C. at pH 3-4.5.

Conclusions. Blue complexes were successfully produced at pH 4 using eggplant ACN, YME and aluminum salt. The blue hue remained when pH was adjusted from 3 to 5. The blue colors remained remarkably stable over 1 month storage at 4° C. at pH 3-4.5.

This project provides the food industry with a potential blue colorant for a wider range of pH application.

MS data is consistent with the formation of the blue complex below, resembling the Blue Hydrangea complex.

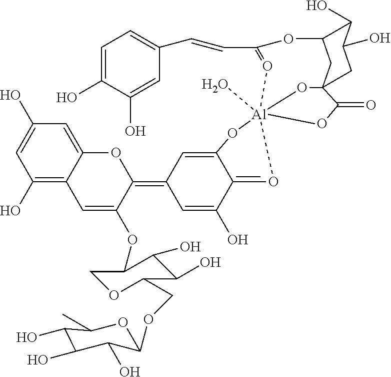

### Example 5—Development of a Vibrant Anthocyanin-Based Blue Colorant for Application in Acid Foods by Simulating the Hydrangea Blue-Complex

Summary: As consumers become more conscious to healthy-eating and clean label foods, sales in natural food colors have also increased. However, it is challenging to find natural blue colorants to substitute synthetic ones since blue edible materials are rare in nature. Anthocyanins are a class of flavonoids abundant in plants and they have been associated with health benefits including anti-cancer, anti-inflammation and neuroprotective activities. They can produce blue color in alkaline conditions, but they are seldom used as blue colorants due to their poor stability in these pHs. In addition, most food products are acidic or neutral, so producing a blue colorant for common food applications is still needed. Yet, in Hydrangea flowers, delphinidin-3-glucoside (Dp3glu) is the major anthocyanin responsible for the color of its flower. These flowers can change color from red to blue by forming a complex at pH 4.0 with three components-Dp3glu, 5-caffeoylquinic acid (5CQA), and Al³⁺. Herein, vibrant, stable anthocyanin-based blue colors are produced in acidic conditions, simulating the conditions found in blue flowers. Edible and readily available plant materials are used to form similar complexes and their behavior and stability in different pHs is explored. Several fruits and vegetable materials and Yerba Mate can be used to obtain Delphinidin, petunidin based anthocyanins with different glycosylation and acylation, and 5CQA, respectively. Complexation can be induced at pH 4 using these extracts and different aluminum salts at varying ratios. Then, the color expression and stability are evaluated at different pHs. This project can help fill the gap of anthocyanin-based vibrant blue colorant for acidic food products.

Introduction. Artificial food colorants have been used to improve consumers' perception of quality and flavor of food products. However, in recent years consumers have become more conscious about making healthier food choices, resulting in increased sales of natural food colors. According to a recent market research by The Natural/Organic Food Shopper (2019), organic food consumers' top two drivers for buying organic are: (1) Organic foods are perceived to be healthier; (2) To avoid artificial ingredients. McCann et al. (2007) reported in a double-blinded trial that consumption of artificial colorants or a sodium benzoate preservative (or both) resulted in increased hyperactivity in 3- and 8/9-year-old children in the general population. Recently, He et al. (2021) reported that metabolites of artificial food colorants Red 40 and Yellow 6 promote colitis in mice. Therefore, the food industry is looking for natural alternatives to replace artificial food colorants.

Blue colors are rare in nature, and therefore, few natural blue colorants are available. Only Spirulina spp. (FDA, 2017) and butterfly pea flower extracts (FDA, 2021) have been approved by the U.S. Food and Drug Administration to be used as natural sources of blue food colorants under specific pHs and uses. Spirulina shows dark blue green to green color. The butterfly pea flower should be used in pH from 3.0 to 4.5 and can provide a bright denim shade (purple blue to blue) at a pH above 3.8.

Anthocyanins contribute to the presence of red to purple color in most of fruits and vegetables, such as grapes (He et al., 2010), blueberries (Yang et al., 2022), red cabbages (Giusti and Wrolstad, 2003) and others. Anthocyanins are a class of polyphenolic compounds that not only provide vibrant colors, but also deliver potential health benefits, such as anti-cancerous, anti-inflammatory, and neuroprotective activities (Malik et al., 2003; Li et al., 2017)—making them great candidates as alternatives for artificial food colorants that meet both consumers' and industry's demands. However, they express blue color usually in alkaline conditions, and only a few food products are in alkaline conditions. Furthermore, anthocyanins are not as stable in alkaline matrices, making their blue color more prone to fading during storage. Recently, horticultural scientists have reported that blue Hydrangea flower could stabilize blue anthocyanins by forming Hydrangea Blue-complex at pH 4 (Ito et al., 2018). This project uses anthocyanins to develop a vibrant and stable blue colorant in acidic conditions by simulating the environment in the blue flower, which provides the food industry with a wider range of pH for blue colors and different shades of blue. In addition, using anthocyanins as colorants in food can increase the consumption of healthier phytochemicals, adding value to food products, and potentially contributing to the overall health of consumers.

Several research studies have shown the possibility of using anthocyanin-rich materials to develop natural blue food colorants. Sigurdson and Giusti (2014) studied several delphinidin and cyanidin based anthocyanins extracted from American eggplant, Japanese eggplant, black currant, red raspberry, chokeberry, red cabbage and black carrot. These anthocyanins chelated with aluminum salt, showed a bathochromic and hyperchromic shift. The bathochromic shift resulted in the anthocyanin color shifting from red to a more blueish hue and hyperchromic shift was observed with an increase in the color intensity. The aluminum salt concentration has less effect in lower anthocyanins concentration. Tang and Giusti (2020) investigated petunidin based anthocyanins from purple potatoes and black goji to form complex with ferric ions and aluminum ions at pHs 3-10. They found purple or blue color in neutral or alkaline conditions, respectively, and bathochromic shifts increased as metal ion concentration increased. More recently, Denish et al. (2021) reported a brilliant blue that simulated the color of FD&C Blue No. 1 by using a specific acylated cyanidin based anthocyanin from red cabbage in combination with aluminum. However, this complex only showed blue color at pH 7.

The Hydrangea Blue-Complex is the main contributor responsible for the Hydrangea color change from red to blue. This complex comprises delphinidin-3-glucoside (Dp3glu), 5-caffeoylquinic acid (5CQA), Al³, and exists when the pH of the sepal is 4 (Ito et al., 2018). This finding provided insights to investigate a new type of anthocyanin complex that could be used in acidic food matrices. Therefore, a goal of this project is to develop a vibrant natural blue colorant in acidic condition using readily available plant materials that combined can simulate the characteristics and performance of the Hydrangea Blue-complex. This goal can be achieved by the following:
1. Reproduce the Hydrangea Blue-Complex using edible plant materials and evaluate their color expression, stability, and structure in different pHs. It is hypothesized that edible food materials such as eggplant peel and Yerba Mate extract will complex similarly to the Hydrangea Blue-Complex at pH 4 with Al³⁺ salt food additive, since they provide the delphinidin-3-rutinoside (Dp3rut) and 5CQA needed for complex formation. This complex can express blue color at pH 4 and have good stability due to the inter-molecular co-pigmentation and coordination with aluminum.
2. Evaluate the ability of additional anthocyanins to form the Blue-complex in pH 4 and study their color expression in acidic pH. It is hypothesized that delphinidin and petunidin based anthocyanins that have glycoside in both 3 and 5 position could also form Blue-complex because of the 2 hydroxyl groups on the B ring. In addition, acylated anthocyanins may prevent blue color formation since intra-molecular co-pigmentation might prevent the formation of metal complex and the interaction with 5CQA.

This project can provide an understanding of the modulation of a reaction documented in a very specific family of flowers and provide the tools to replicate those complexes in food matrices. These results can allow production of a new natural blue colorant derived from readily available edible materials for use by the food industry in a wider range of pH applications.

Rationale and Significance. With the increasing consumers' demands of heathier and clean label food, the food industry is looking for food colorants sourced from nature with higher stability and versatility. Blue is one of the most challenging colors to extract from nature. Newsome et al. (2014) reported that “Blue colors are not uncommon in nature but are extremely difficult to replicate in foods and beverages”. Scientists have spent many years looking for vibrant and stable natural blue colorant for food products, but there are many more solutions yet to be discovered.

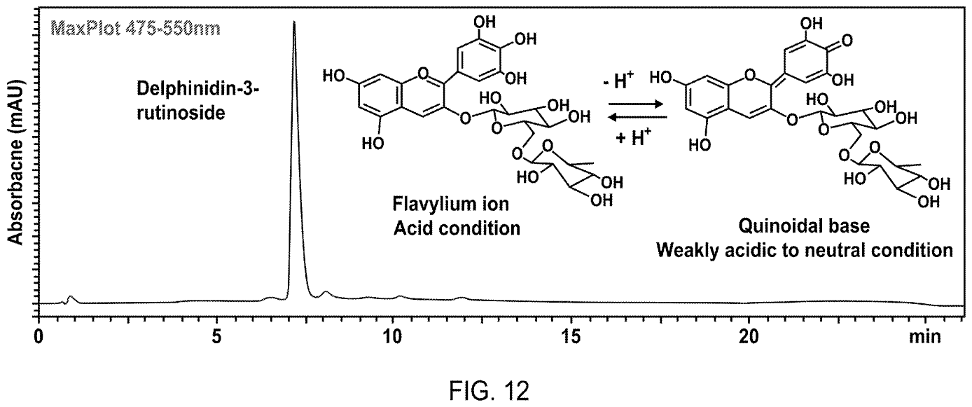

Anthocyanins are a class of flavonoid widely distributed in fruits, vegetables, and flowers. The basic structure of anthocyanins is 2-phenylbenzopyrylium of flavylium salt. There are six anthocyanin aglycones that are commonly found in food. The color, stability and structural form of anthocyanins depend on pH. In pH 1-3, anthocyanins have the greatest stability due to the dominance of red flavylium cation structures, while in pH 4-6, the colorless carbinol or colorless chalcone dominates. In alkaline conditions, anthocyanins are present as blue quinonoidal base form (Damodaran and Parkins, 2017) (FIG. 12). Unfortunately, anthocyanins are unstable in alkaline conditions and few food products are in alkaline condition. Therefore, it is important to find a condition that could stabilize this blue quinonoidal base anthocyanin.

Hydrangea (Hydrangea macrophylla) is a plant originally from Japan and East Asia. This plant has sparked scientific interest since the 19^{th} century, because its flower has the ability to change color from red to purple to blue. This unique phenomenon is caused by chemical reactions rather than gene expression (Yoshida et al., 2021). The major anthocyanin in the Hydrangea flower is Dp3glu and the copigmentation components are 5CQA, 3-caffeoylquinic acid (3CQA), and 5-p-coumaroylquinic acid (Yoshida et al., 2021). These components are present in all Hydrangea flowers regardless of their color. The differences between the red and blue flowers have been reported to be:
1. Blue flowers have higher content of 5CQA and Al³⁺ than red flowers (Toyama-Kato et al., 2007).
2. The average vacuolar pH of blue cells is 4.1, and 3.3 in the red cells (Yoshida et al., 2003).

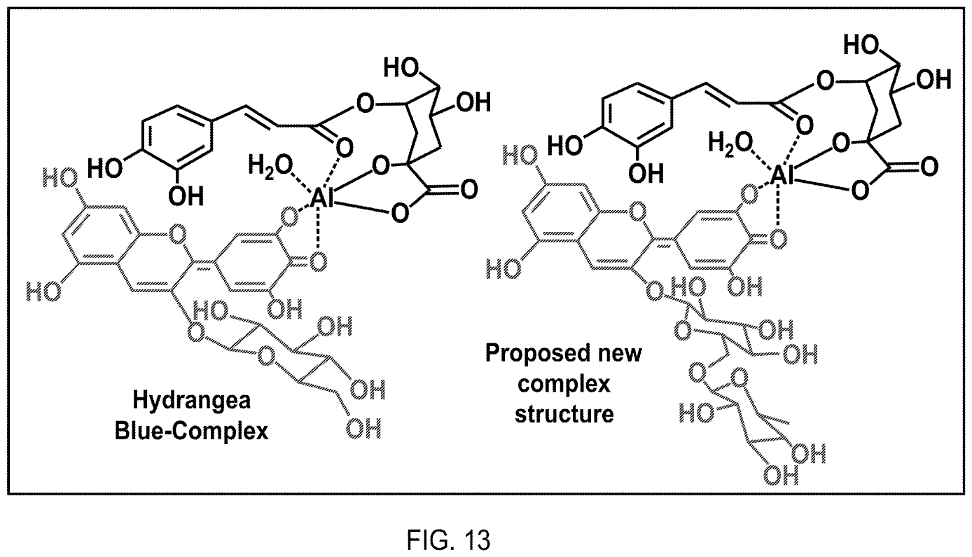

These differences provide suitable conditions for the flower to form what is known as the Hydrangea Blue-Complex. Ito et al. (2018) identified the structure (FIG. 13) of the Hydrangea Blue-complex by ESI-Mass-spectrometry. Their team also determined that the 1-OH, 1-COOH, and 5-ester are essential components of the copigment to form the Hydrangea Blue-complex (Toyama-Kato et al., 2007). In addition, the size of the aromatic component of the 5-acyl moiety increased stability of the complex, which might be explained by copigmentation between aromatic component and anthocyanidin chromophore through hydrophobic interaction (Yoshida et al., 2021). For the anthocyanin, at least two hydroxy groups on the B ring are important for the formation of this complex (Toyama-Kato et al., 2007).

Knowing the chemical mechanisms of Hydrangea Blue-Complex provides an inspiration for producing a new, stable natural blue food colorant. American eggplant peel contains simple profile of anthocyanin, comprising mostly Dp3rut, which comprises an aromatic structure that important for this complex formation. Yerba Mate contains 5CQA which meets all criteria of copigment that is suitable for complex formation.

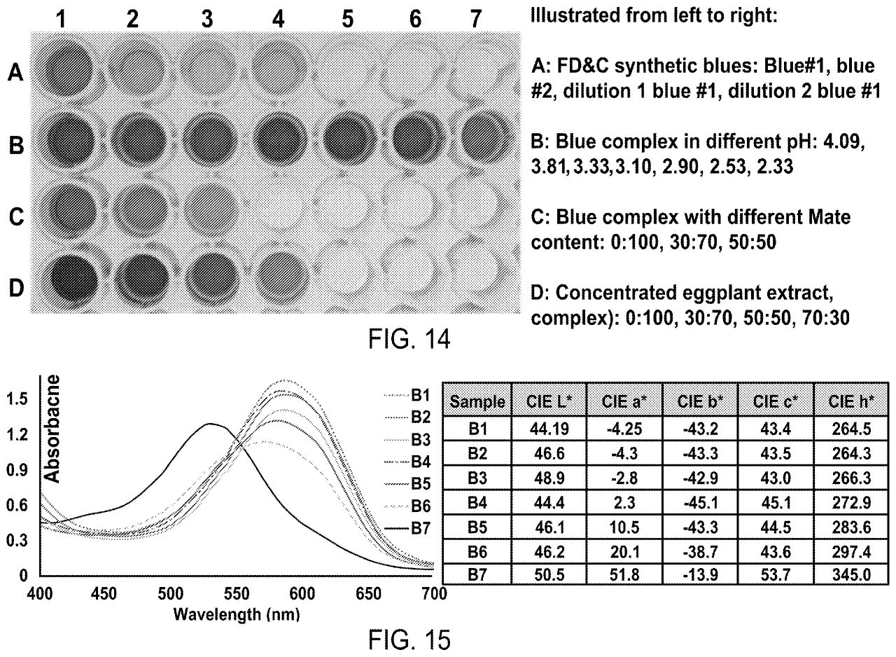

Results. In a preliminary study, eggplant peel extract, Yerba Mate extract, and AlCl₃ were mixed at pH 4 buffer. This resulted in a vibrant and stable blue color; the proposed structure is shown in FIG. 13. Then, the pH was lowered from 4.09 to 2.33 by adding diluted HCl. Surprisingly, the complex showed blue color even when the pH was decreased to 2.90 (FIG. 14, B row), and the λₘₐₓ and hue value did not significantly change when the pH was lowered from 4.09 to 3.33 (FIG. 15). From pH 3.10 to 2.90, the complexes started turning from blue to purple-ish blue color. At pH 2.52 and 2.33, there were hypsochromic shifts in spectra and larger hue values. It was also overserved that the blue color remained vibrant for at least 3 months in 4 degrees C. Besides pHs, 5CQA and Dp3rut concentration also influenced color expression. The concentrated 5CQA resulted in the loss of chroma, while concentrated Dp3rut resulted in the increase of color intensity and absorbance at λₘₐₓ.

Even though delphinidin based anthocyanin could be found in nature, it is hard to find fruits and vegetables with a single anthocyanin type. In most fruit and vegetables, anthocyanins present could be derived from other aglycones such as cyanidin, peonidin, petunidin, or others. In turn, these aglycones could have different glycosylation patterns with sugars in different positions and with or without acylating groups. Therefore, it is important to know if the sugar positions and acylated groups could affect the formation of the blue complex and its color expression. Oyama et al. (2015) found that cyanidin-3-glucoside could also form blue color when it was complexed with 5CQA and Al³⁺ due to the o-dihydroxy group in the B ring. However, there are currently no publications evaluating the complex formation with petunidin, another anthocyanin with a o-dihydroxy group in the B ring. Similarly, no information was found on the impact of glycosylation type and position, or presence of acylation on the blue complex formation and color expression.

Example anthocyanins that can be investigated are shown below in Scheme 1.

Scheme 1. Example anthocyanins

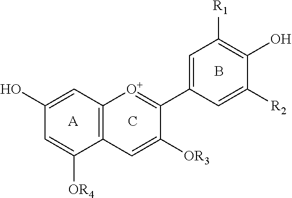

| Anthocyanins | R1 | R2 | R3 | R4 |
|---|---|---|---|---|
| Pelargonidin | H | H | H | H |
| Cyanidin | OH | H | H | H |
| Delphinidin | OH | OH | H | H |
| Petunidin | OH | OCH₃ | H | H |
| American eggplant | OH | OH | Rutinoside | H |
| Black goji | OH | OCH₃ | p-coumaroyl- | glucoside |
| | | | rutinoside | |

Development of anthocyanin based natural blue colorant will address agricultural, food, environmental or societal issues. The formation of the blue complex discussed herein does not require complicated procedures such as high temperature, incubation for long periods, or enzymatic treatment. The procedure described herein uses a simple combination of eggplant, Yerba Mate extract and Al³⁺ salt, which makes this method accessible and easily attainable for any small- or large-scale production. Moreover, the improvement in production efficiency could decrease pollution and the waste generated by producing synthetic colorants.

### Approach—Research Design and Data Analysis

Reproduce the Hydrangea Blue-Complex using edible plant materials and evaluate their color expression, stability, and structure in different pHs. Eggplant, rich in Dr-3-rut was chosen as the source of anthocyanins and Yerba Mate was selected as a rich source of 5CQA. Eggplant peel crude extract will be mixed with Yerba Mate CQA rich fraction (YMF) and Al³ solvent to form blue complex in pH 4.0 buffer. Then, HCl and NaOH were used to adjust the pH of the solutions to 2.5 to 7.1. The colorimetric and spectral characteristics of anthocyanin-based blue complex, and commercially available blue food colorants (synthetic blue and butterfly pea flower extract) will be evaluated from pH 2.5 to 7.1. All samples will be stored in 4° C. to evaluate their stabilities for over six months. Selected blue complexes samples will be measured by circular dichroism (CD) and directly injected into ESI-Fourier-transform ion cyclotron resonance (FT-ICR) to further explore their structures.

It is hypothesized that edible food materials such as eggplant peel and Yerba Mate extract will complex similarly to the Hydrangea Blue-Complex at pH 4 with Al³ salt food additive, since they provide the Dp3rut and 5CQA needed for complex formation. This complex can express blue color at pH 4 and have good stability due to the inter-molecular co-pigmentation and coordination with aluminum.

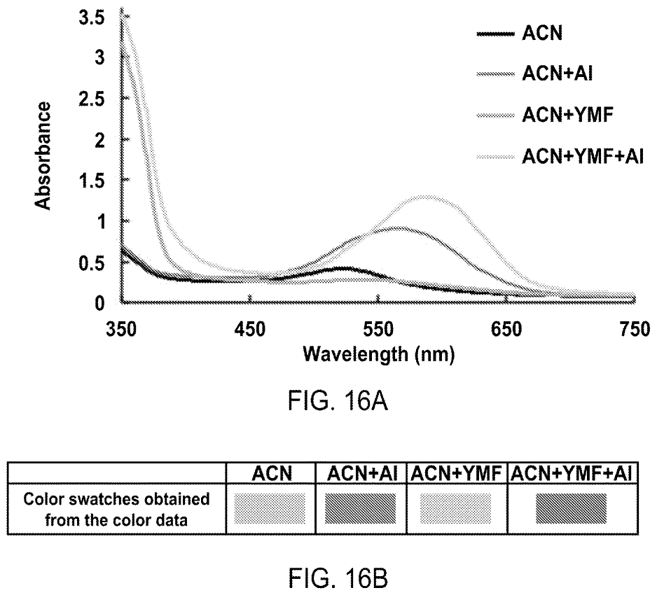

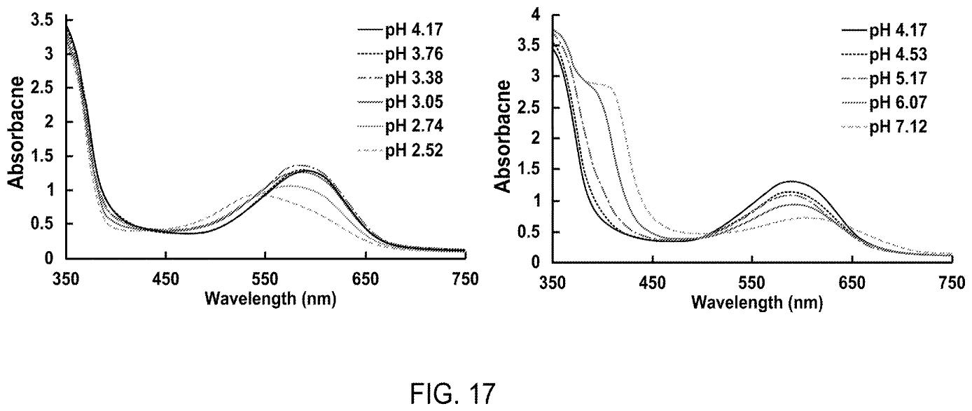

A blue complex has been successfully formed in pH 4 using eggplant peel anthocyanin, YMF and Al₂(SO₄)₃ (FIG. 16A-FIG. 16B). Aluminum sulfate has been recognized as safe by the FDA. ACN+YMF+Al produced blue color and had the largest bathochromic shift, which was the typical characteristic of blue complex (Table 2). The blue color was retained when the pH was decreased to pH 3-5 (FIG. 17). When the pH dropped to 2.74, there was a hypsochromic shift and the color turned to purplish blue. When the pH increased to 6.07, there was a bathochromic shift and the color turned to greenish blue.

The blue complex solutions at different pH were directly injected into nano-ESI-FT-ICR mass spectrometry and measured in CD to study the structure changes across the pHs. The expected 989.21 corresponding to the blue complex was detected only in some of the samples, and at a low intensity. It is speculated that the blue color developed in the samples may change during the injection, or during storage. It is also possible that the blue complex structure obtained may be slightly different from the Hydrangea Blue-Complex due to the ratio between ACN, YME and A1.

Besides identification of the structure of blue complex, color stability of the samples stored at refrigerated temperature was monitored. Samples at pH 3.38 to pH 4.17 remained blue for over 5 months of refrigerated storage.

Evaluate the ability of additional anthocyanins to form the Blue-complex in pH 4 and study their color expression in acidic pH. Chinese eggplant peel crude extract containing majorly delphinidin-3-(p-coumaroylrutinoside)-5-glucoside (Jing et al., 2015) and black Goji crude extract containing petunidin-3-(p-coumaroylrutinoside)-5-glucoside (Tang & Giusti, 2020) will be saponified to obtain non-acylated anthocyanins. Then, both crude and alkaline hydrolyzed extract will be mixed with YMF extract and Al³⁺ solvent to form blue complex at pH 4.0. The blue complex spectra (350-700 nm) will be compared to the control samples: anthocyanin at pH 4, anthocyanin and Al³ at pH 4 and anthocyanin with Yerba Mate extract at pH 4. Then, HCl and NaOH will be used to adjust pH of blue complex from 2.5 to 7.1. The spectra will also be compared with the blue complex formed above in order to determine if glycosylation in both position 3 and 5 will affect color and complex formation.

Delphinidin and petunidin based anthocyanins that have glycoside in both 3 and 5 position could also form Blue-complex because of the 2 hydroxyl groups on the B ring. In addition, acylated anthocyanins may prevent blue color formation since intra-molecular co-pigmentation might prevent the formation of metal complex and the interaction with 5CQA.

The blue complex could also be formed by delphinidin and petunidin based anthocyanin with glycoside in both 3 and 5 position. There can be a significant bathochromic shift comparing with all control samples. However, anthocyanins with acylation may not have blue color and there will not be bathochromic shift comparing with ACN+A1 sample.

Additional items. Preliminary experiments found that buffer solutions may have effects on complex formation. In this project, pH 4 sodium acetate buffer will be used for all experiments and pH will be adjusted by HCl or NaOH to keep consistent.

4-caffeoylquinic acid (4CQA) was also found in Yerba Mate extract and there was no literature working on if 4CQA could form complex or affect color expression of anthocyanins. The Yerba Mate needed for all experiments will be extracted and freeze dried, and the ratio between 5CQA and 4CQA can be reported. However, the color expression of the complex may be a little bit different than using pure compounds.

### Methods

Pigment extraction from eggplant peel and black goji. Eggplant peel and black goji will be frozen by liquid nitrogen immediately. Then, frozen samples will be pulverized and extracted with acidified (2% HCl) 70% MeOH and sonicated for 15 min. The crude extract will be filtered then re-extracted two more times until the peel is colorless. MeOH will be removed by a rotary evaporator and rest of extract will be further purified by solid phase extraction with acidified water and ethyl acetate. Then, samples will be recovered by 0.01% HCl in MeOH. Samples will be further concentrated then dissolved into 0.01% HCl in water.

Pigment saponification. Chinese eggplant and black goji extract will be saponified by 10% KOH in dark for 10 min. Then, 2N HCl will be added to the samples until the color turns to red. Saponified extract will be further purified by solid phase extraction with acidified water and ethyl acetate. Then, samples will be recovered by 0.01% HCl in MeOH. Samples will be further concentrated then dissolved into 0.01% HCl in water.

Yerba Mate extraction and fractionation. Yerba Mate will be extracted by adding 10× of boiling water and allowing it to 30 min at room temperature. Then, the supernatant will be filtered. Solid phase extraction will be performed to obtain CQA enriched fraction. 10% MeOH fraction will be collected and freeze dried. The freeze-dried powder will be weighed and dissolved in water (2%). This solution will be used as the Yerba Mate CQA rich fraction (YMF).

Anthocyanin quantification. Anthocyanin quantity can be measured using the pH differential method detailed by Giusti and Wrolstad (2001) and expressed as cyanidin-3-glucoside equivalents.

Anthocyanin and 5CQA identification. Anthocyanin and 5CQA can be analyzed using an UHPLC-PDA-ESI-MS/MS. The separated analytes can be monitored under the absorbance of 520 nm or 325 nm and further characterized by their molecular ions and their respective fragments. 5CQA quantification can be performed by a 5-point external standard.

Spectral characterization and colorimetric measurement. Spectral characterization and colorimetric measurement can be carried out using a SpectraMax M2 Microplate Reader within the visible range (380-650 nm), and their changes in spectral shifts and absorbance can be monitored. Spectral data can be converted to colorimetric values using ColorBySpectra software. Colorimetric values can be expressed by CIELAB (L*, a*, b*, and L*, C*ab, hab) values. These values can be used to calculate the total color change (AE*ab) in order to determine if color changes could be detected by untrained consumers.

Circular Dichroism. A Jasco J-1500 Circular Dichroism (CD) Spectrometer can be used to analyze the spectra of the blue complex within the visible range (350-800 nm).

Nano-ESI-FT-ICR-MS. Samples can be filtered through 0.22 um membranes and directly injected into nano-ESI-FT-ICR mass spectrometry.

Data analysis. Spectral and colorimetric data can be analyzed by two-way or one-way ANOVA followed by post hoc analysis to determine which parameters are significantly affecting color expression. For stability experiments, regression can be used to determine the color change during the storage. All data analysis can be performed by JMP Pro 14.0 software.

### REFERENCES

Ahmadiani, N., Baroni, S., Dangles, O., Giusti, M., Collins, T. M., Didzbalis, J., . . . Robbins, R. J. (2021). Discovery of a natural cyan blue: A unique food-sourced anthocyanin could replace synthetic brilliant blue. American Association for the Advancement of Science (AAAS). 10.1126/sciadv.abe7871
Alkaya, G. B., Demirci, Ç, & Şevik, H. (2022). Aluminum in food and potential role on Alzheimer's disease of aluminum. Turkish Journal of Engineering (TUJE), 6(2), 118-127. 10.31127/tuje.846455
Castañeda-Ovando, A., Pacheco-Hernández, M. d. L., Páez-Hernindez, M. E., Rodriguez, J. A., & Galán-Vidal, C. A. (2009). Chemical studies of anthocyanins: A review. Food Chemistry, 113(4), 859-871. 10.1016/j.foodchem.2008.09.001
Code of Federal Regulations Title 21, Aluminum sulfate: https://www.accessdata.fda.gov/scripts/cdrh/cfdocs/cfcfr/CFRSearch.cfm?fr-182.1125
Code of Federal Regulations Title 21, Butterfly pea extract: https://www.accessdata.fda.gov/scripts/cdrh/cfdocs/cfcfr/CFRSearch.cfm?fr-73.69
Code of Federal Regulations Title 21, Spirulina extract: https://www.accessdata.fda.gov/scripts/cdrh/cfdocs/cfcfr/CFRSearch.cfm?fr-73.530
Consumers drivers for buying organic food: https://reports-mintel-com.proxy.lib.ohio-state.edu/display/1032821/?fromSearch=%3Ffreetext%3Dfood%2520color&resultPosition=39
Damodaran, S., & Parkin, K. L. (Eds.). (2017). Fennema's Food Chemistry (5th ed.). CRC Press. https://doi.org/10.1201/9781315372914
Denish, P. R., Fenger, J., Powers, R., Sigurdson, G. T., Grisanti, L., Guggenheim, K. G., Laporte, S., Li, J., Kondo, T., Magistrato, A., Moloney, M. P., Riley, M., Rusishvili, M., Ahmadiani, N., Baroni, S., Dangles, O., Giusti, M., Collins, T. M., Didzbalis, J., . . . Robbins, R. J. (2021). Discovery of a natural cyan blue: A unique food-sourced anthocyanin could replace synthetic brilliant blue. American Association for the Advancement of Science (AAAS). 10.1126/sciadv.abe7871
Giusti, M. M., & Wrolstad, R. E. (2003). Acylated anthocyanins from edible sources and their applications in food systems. Biochemical Engineering Journal, 14(3), 217-225. 10.1016/S1369-703X(02)00221-8
Giusti, M. M., Wrolstad, R. E. (2001). Characterization and Measurement of Anthocyanins by UV-Visible Spectroscopy. Curr. Protoc. Food Analytical. Chemistry, 5, :1-13.
He, F., Mu, L., Guo-Liang Yan, Na-Na Liang, Qiu-Hong Pan, Wang, J., Reeves, M. J., & Chang-Qin Duan. (2010). Biosynthesis of anthocyanins and their regulation in coloured grapes. Molecules, 15(12), 9057-9091. https://proxy.lib.ohio-state.edu/login?url=https://search.ebscohost.com/login.aspx?direct=true&db=ffh&AN=2011-04-Jg1776&site=ehost-live
He, Z., Chen, L., Catalan-Dibene, J., Bongers, G., Faith, J. J., Suebsuwong, C., DeVita, R. J., Shen, Z., Fox, J. G., Lafaille, J. J., Furtado, G. C., & Lira, S. A. (2021). Food colorants metabolized by commensal bacteria promote colitis in mice with dysregulated expression of interleukin-23. Cell Metabolism, 33(7), 1358-1371.e5. 10.1016/j.cmet.2021.04.015
Ito, T., Oyama, K., & Yoshida, K. (2018). Direct Observation of Hydrangea Blue-Complex Composed of 3-O-Glucosyldelphinidin, A13+ and 5-O-Acylquinic Acid by ESI-Mass Spectrometry. Molecules, 23(6), 1424. 10.3390/molecules23061424
Jing, P., Qian, B., Zhao, S., Qi, X., Ye, L., Mónica Giusti, M., & Wang, X. (2015). Effect of glycosylation patterns of chinese eggplant anthocyanins and other derivatives on antioxidant effectiveness in human colon cell lines. Food Chemistry, 172, 183-189. doi:10.1016/j.foodchem.2014.08.100
Li, D., Wang, P., Luo, Y., Zhao, M., & Chen, F. (2017). Health benefits of anthocyanins and molecular mechanisms: Update from recent decade. Critical Reviews in Food Science and Nutrition, 57(8), 1729-1741. 10.1080/10408398.2015.1030064
Malik, M., Zhao, C., Schoene, N., Guisti, M. M., Moyer, M. P., & Magnuson, B. A. (2003). Anthocyanin-Rich Extract From Aronia meloncarpa E. Induces a Cell Cycle Block in Colon Cancer but Not Normal Colonic Cells. Nutrition and Cancer, 46(2), 186-196. 10.1207/S15327914NC4602_12
McCann, D., Barrett, A., Cooper, A., Crumpler, D., Dalen, L., Grimshaw, K., Kitchin, E., Lok, K., Porteous, L., Prince, E., Sonuga-Barke, E., Warner, J. O., & Stevenson, J. (2007). Food additives and hyperactive behaviour in 3-year-old and 8/9-year-old children in the community: a randomised, double-blinded, placebo-controlled trial. The Lancet, 370(9598), 1560-1567. https://doi.org/10.1016/S0140-6736(07)61306-3
Newsome, A. G., Culver, C. A., & van Breemen, R. B. (2014). Nature's Palette: The Search for Natural Blue Colorants. Journal of Agricultural and Food Chemistry, 62(28), 6498-6511. 10.1021/jf501419q
Oyama, K., Yamada, T., Ito, D., Kondo, T., & Yoshida, K. (2015). Metal Complex Pigment Involved in the Blue Sepal Color Development of Hydrangea. Journal of Agricultural and Food Chemistry, 63(35), 7630-7635. 10.1021/acs.jafc.5b02368
Sigurdson, G. T., & Giusti, M. M. (2014). Bathochromic and Hyperchromic Effects of Aluminum Salt Complexation by Anthocyanins from Edible Sources for Blue Color Development. Journal of Agricultural and Food Chemistry, 62(29), 6955-6965. 10.1021/jf405145r
Tang, P., & Giusti, M. M. (2020). Metal Chelates of Petunidin Derivatives Exhibit Enhanced Color and Stability. Foods, 9(10), 1. 10.3390/foods9101426
Toyama-Kato, Y., Kondo, T., & Yoshida, K. (2007). Synthesis of designed acylquinic acid derivatives involved in blue color development of Hydrangea and their co-pigmentation effect.10.3987/COM-06-S(K)6
Yang, W., Guo, Y., Liu, M., Chen, X., Xiao, X., Wang, S., Gong, P., Ma, Y., & Chen, F. (2022). Structure and function of blueberry anthocyanins: A review of recent advances. Journal of Functional Foods, 88, 104864. 10.1016/j.jff.2021.104864
Yoshida, K., Oyama, K., & Kondo, T. (2021). Insight into chemical mechanisms of sepal color development and variation in Hydrangea. Proceedings of the Japan Academy. Series B, Physical and Biological Sciences, 97(2), 51-68. 10.2183/pjab.97.003
Yoshida, K., Toyama-Kato, Y., Kameda, K., & Kondo, T. (2003). Sepal Color Variation of Hydrangea macrophylla and Vacuolar pH Measured with a Proton-Selective Microelectrode.

Plant and Cell Physiology, 44(3), 262-268. 10.1093/pcp/pcg033

### Example 6

A vibrant and stable anthocyanin-based blue colorant from eggplant and Yerba Mate for use in acidic environments is described herein.

Anthocyanins (ACN) from American eggplant peel and black Goji were extracted and purified. 5CQA was fractionated from Yerba Mate hot water extract (YME) and freeze dried. ACN and 5CQA were combined with an aluminum salt and mixed in a pH 4 buffer.

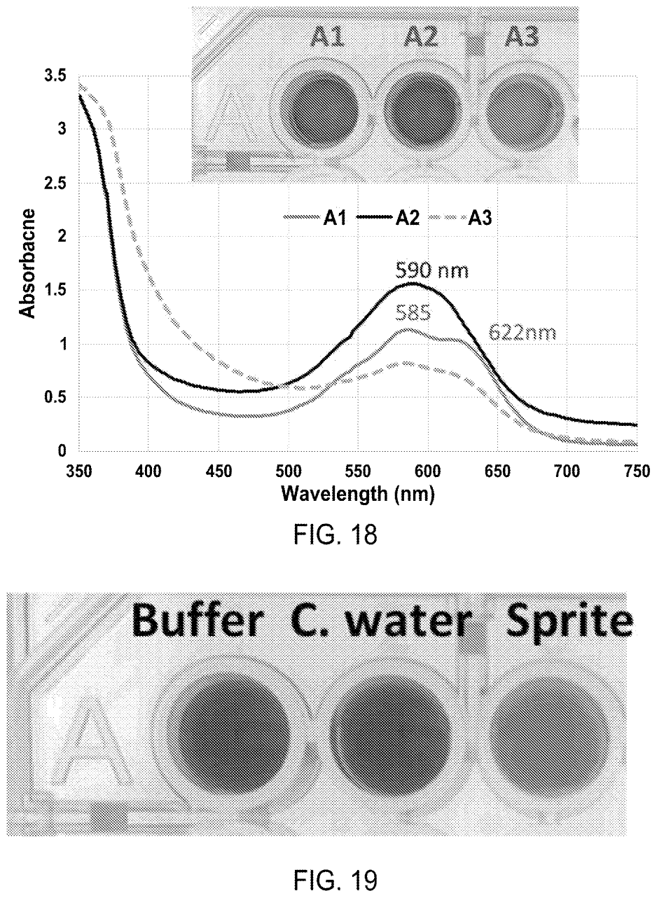

Results for acylated black goji complex (A1), American eggplant complex (A2), and Non-acylated black goji complex (A3) are shown in FIG. 18. The blue color obtained with black goji shows that it is possible to form the blue complex with Petunidin (Pt) derivatives, even if acylated. The blue color obtained with Pt had less red tones, making it more desirable for some food applications. The American eggplant complex is the previously tested complex (above). The non-acylated black goji extract had yellow color in pH 4.5 and the color was brown when doing the SPE.

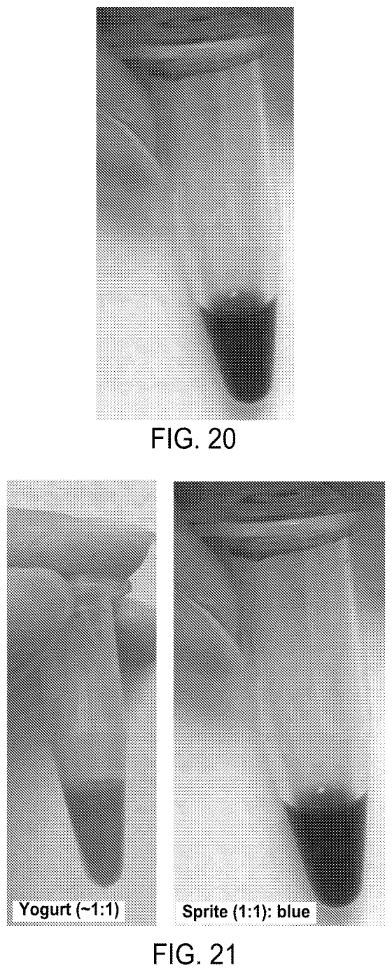

The eggplant extract was further tested with lower A1 concentration and in a variety of solvents. For example, the complex was challenged in two different beverages, Waterloo Sparking water (black cherry flavor) and Sprite, to test the color stability under a real world food industry setting. As a control, the complex was tested in buffer. An example solution was prepared by combining 70 ul eggplant extract, 140 ul Yerba Mate extract, 140 ul A1 (5 mM, AlCl₃·6H₂O), 280 ul buffer, and 105 ul Water. The results for the complex in pH 4 buffer (1:1), Waterloo Sparkling Water (1:1), and Sprite (1:1) are shown in FIG. 19. The initial pH buffer was 4; the pH for the resulting mixture was 4.1 and exhibited a blue color. The pH of the Waterloo Sparkling Water was 3.86; the pH for resulting mixture was 4.14 and exhibited a blue color. The pH of Sprite is only 3.3; the pH for the mixture was 3.64 and exhibited a pink color. Sprite contains citric acid, which can act as a chelating agent. Thus, it was hypothesized that the pink color could be due to the aluminum salt being chelated by the citric acid, and thus being unavailable for blue complex formation. To test this hypothesis, additional aluminum was added (100× as proof of concept), and the resulting mixture exhibited a vibrant blue color (FIG. 20).

Additional tests were performed with a higher A1 concentration (250 mM, Al₂(SO₄)₃(18H₂O)). For example, the complex was challenged in two different mixtures, one in yogurt and another in Sprite, to again test the color stability under a real world food industry setting. An example solution was prepared by combining 70 ul eggplant extract, 140 ul Yerba Mate extract, 140 ul Al (250 mM, Al₂(SO₄)₃(18H₂O)), 280 ul buffer, and 105 ul Water. The results for the complex in Yogurt (~1:1) and Sprite (1:1) are shown in FIG. 21. Both exhibited a blue color.

To form the blue complex, a balance of all three ingredients is needed. The ratio of the three ingredients can vary somewhat, but a certain minimum of each ingredient is needed and a certain pH range is needed during complex formation to successfully form the blue complex. Once the blue complex is successfully formed, the pH can then be changed to a certain extent while the blue color remains stable.

### EXEMPLARY ASPECTS

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: A colorant composition comprising: an aluminum salt; an anthocyanidin, an anthocyanin, or a combination thereof; and a caffeoylquinic acid; wherein the colorant is blue at pH2.9 to 3.3.

Example 2: A colorant composition comprising: an aluminum salt; an anthocyanidin, an anthocyanin, or a combination thereof; and a caffeoylquinic acid; wherein the colorant is edible and/or wherein at least a portion of the composition is an extract of an edible material.

Example 3: The colorant of any examples herein, particularly example 1 or example 2, wherein the composition is an aqueous composition.

Example 4: The colorant of any examples herein, particularly examples 1-3, wherein the composition is an aqueous composition having a pH from 1-7, from 2-7, from 3-7, from 4-7, from 5-7, from 6-7, from 5-6, from 4-6, from 3-6, from 4-5, from 3-5, or from 3.5-4.5.

Example 5: The colorant of any examples herein, particularly examples 1-4, wherein the composition is an aqueous composition having a pH from 2.9 to 5, from 2.9 to 4, or from 3.3 to 4.

Example 6: The colorant of any examples herein, particularly examples 1-5, wherein the aluminum salt is an Al³⁺ salt.

Example 7: The colorant of any examples herein, particularly examples 1-6, wherein the aluminum salt is AlCl₃, Al₂(SO₄)₃, aluminum hydroxide, aluminum oleate, aluminum palmitate, aluminum ammonium sulfate, aluminum potassium sulfate, aluminum sodium sulfate, sodium aluminum phosphate, aluminum calcium silicate, sodium aluminosilicate, or a combination thereof.

Example 8: The colorant of any examples herein, particularly examples 1-7, wherein the aluminum salt is AlCl₃, Al₂(SO₄)₃, or a combination thereof.

Example 9: The colorant of any examples herein, particularly examples 1-8, wherein the aluminum salt is present at a concentration from 0.1-100 mM, from 1-100 mM, from 5-100 mM, from 10-100 mM, from 25-100 mM, from 50-100 mM, from 0.1-10 mM, from 1-10 mM, from 1-5 mM, from 5-10 mM, from 5-25 mM, or from 0.1-2.5 mM.

Example 10: The colorant of any examples herein, particularly examples 1-9, wherein the anthocyanidin or anthocyanin is of Formula I:

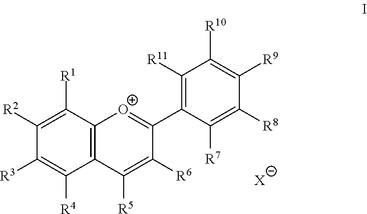

wherein
X is an acceptable anion (e.g., chloride, bromide, iodide, nitrate, sulfate, hydrogen sulfate, phosphate, hydrogen phosphate, dihydrogen phosphate, acetate, etc.);
R¹ is H, OH, OCH₃, or OR^{S}.
R² is H, OH, OCH₃, or OR^{S}.
R³ is H, OH, OCH₃, or OR^{S}.
R⁴ is H, OH, OCH₃, or OR^{S}.
R⁵ is H, OH, OCH₃, or OR^{S};
R⁶ is H, OH, OCH₃, or OR^{S};
R⁷ is H, OH, OCH₃, or OR^{S};
R⁸ is H, OH, OCH₃, or OR^{S};
R⁹ is H, OH, OCH₃, or OR^{S};
R¹⁰ is H, OH, OCH₃, or OR^{S};
R¹¹ is H, OH, OCH₃, or OR^{S}; and
each R^{S} independently is a sugar, an acid, or a combination thereof.

Example 11: The colorant ofany examples herein, particularly example 10, wherein each R^{S} independently can be a sugar (e.g., a hexose, a pentose, a deoxyhexose, etc.) optionally with an acid (e.g., hydroxycinnamic acid, aliphatic acids, etc.) attached to said sugar.

Example 12: The colorant of any examples herein, particularly example 10 or example 11, wherein R^{S} is in each case independently has the formula:

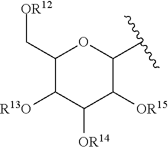

wherein
R¹² is H or monosaccharide;
R¹³ is H or monosaccharide;
R¹⁴ is H or monosaccharide; and
R¹⁵ is H or monosaccharide.

Example 13: The colorant of any examples herein, particularly examples 10-12, wherein the anthocyanidin or anthocyanin is of Formula I:

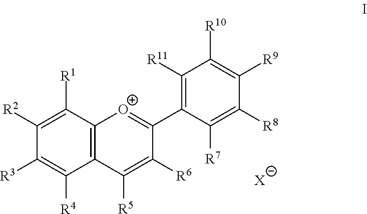

wherein
X is an acceptable anion (e.g., chloride, bromide, iodide, nitrate, sulfate, hydrogen sulfate, phosphate, hydrogen phosphate, dihydrogen phosphate, acetate, etc.);
R¹ is H, OH, OCH₃, or OR^{S};
R² is H, OH, OCH₃, or OR^{S};
R³ is H, OH, OCH₃, or OR^{S};
R⁴ is H, OH, OCH₃, or OR^{S};
R⁵ is H, OH, OCH₃, or OR^{S};
R⁶ is H, OH, OCH₃, or OR^{S};
R⁷ is H, OH, OCH₃, or OR^{S};
R⁸ is H, OH, OCH₃, or OR^{S};
R⁹ is H, OH, OCH₃, or OR^{S};
R¹⁰ is H, OH, OCH₃, or OR^{S};
R¹¹ is H, OH, OCH₃, or OR^{S}; and
R^{S} is in each case independently has the formula:

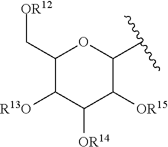

wherein
R¹² is H or monosaccharide;
R¹³ is H or monosaccharide;
R¹⁴ is H or monosaccharide; and
R¹⁵ is H or monosaccharide.

Example 14: The colorant of any examples herein, particularly examples 10-13, wherein R⁶ is OR^{S}.

Example 15: The colorant of any examples herein, particularly examples 10-14, wherein R⁸ is OH.

Example 16: The colorant of any examples herein, particularly examples 10-15, wherein R⁹ is OH.

Example 17: The colorant of any examples herein, particularly examples 10-16, wherein R¹⁰ is OH.

Example 18: The colorant of any examples herein, particularly examples 10-17, wherein at least one of R⁸ and R¹⁰ is OH.

Example 19: The colorant of any examples herein, particularly examples 10-18, wherein R⁸ and R⁹ are each OH.

Example 20: The colorant of any examples herein, particularly examples 10-19, wherein R⁹ and R¹⁰ are each OH.

Example 21: The colorant of any examples herein, particularly examples 10-20, wherein R⁸, R⁹, and R¹⁰ are each OH.

Example 22: The colorant of any examples herein, particularly examples 10-21, wherein R⁷ is H.

Example 23: The colorant of any examples herein, particularly examples 10-22, wherein R¹¹ is H.

Example 24: The colorant of any examples herein, particularly examples 10-23, wherein R⁷ and R¹¹ are each H.

Example 25: The colorant of any examples herein, particularly examples 10-24, wherein R² and R⁴ are each OH.

Example 26: The colorant of any examples herein, particularly examples 10-25, wherein R¹ and R³ are each OH.

Example 27: The colorant of any examples herein, particularly examples 10-26, wherein R² and R⁴ are each H.

Example 28: The colorant of any examples herein, particularly examples 10-27, wherein R¹ and R³ are each H.

Example 29: The colorant of any examples herein, particularly examples 10-28, wherein R¹, R³, R⁵, R⁷, and R¹¹ are each H.

Example 30: The colorant of any examples herein, particularly examples 10-29, wherein R², R⁴, and R⁹ are each independently OH, OCH₃, or OR^{S}.

Example 31: The colorant of any examples herein, particularly examples 10-30, wherein R¹, R³, R⁵, R⁷, and R¹¹ are each H, and R², R⁴, and R⁹ are each independently OH, OCH₃, or OR^{S}.

Example 32: The colorant of any examples herein, particularly examples 1-31, wherein the anthocyanidin or anthocyanin is of Formula II:

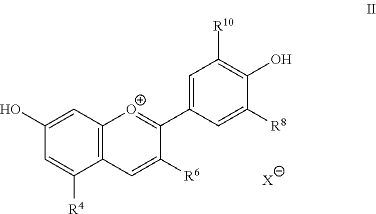

wherein
R⁴ is OR^{S};
R⁶ is OR^{S};
R⁸ is H, OH, or OCH₃; and
R¹⁰ is H, or OH;
R^{S} in each case independently has the formula:

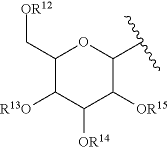

wherein
R¹² is H or monosaccharide;
R¹³ is H or monosaccharide;
R¹⁴ is H or monosaccharide; and
R¹⁵ is H or monosaccharide.

Example 33: The colorant of any examples herein, particularly examples 10-32, wherein each R^{S} independently is:

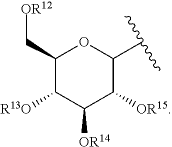

Example 34: The colorant of any examples herein, particularly examples 10-33, wherein R³ is H.

Example 35: The colorant of any examples herein, particularly examples 10-34, wherein R¹⁴ is H.

Example 36: The colorant of any examples herein, particularly examples 10-35, wherein R⁵ is H.

Example 37: The colorant of any examples herein, particularly examples 10-36, wherein R¹³, R¹⁴, and R¹⁵ are each H.

Example 38: The colorant of any examples herein, particularly examples 10-37, wherein R¹² is H.

Example 39: The colorant of any examples herein, particularly examples 10-37, wherein R¹² has the formula:

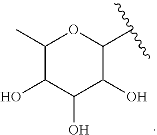 [SMILES: *C1OC(C)C(O)C(O)C1O]

Example 40: The colorant of any examples herein, particularly examples 10-37, wherein R¹² has the formula:

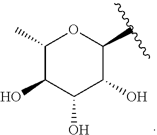 [SMILES: *[C@@H]1O[C@@H](C)[C@H](O)[C@@H](O)[C@H]1O]

Example 41: The colorant of any examples herein, particularly examples 10-40, wherein R^{S} has the formula:

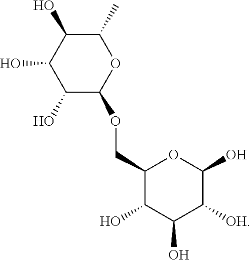 [SMILES: C[C@@H]1O[C@@H](OC[C@H]2O[C@@H](O)[C@H](O)[C@@H](O)[C@@H]2O)[C@H](O)[C@H](O)[C@H]1O]

Example 42: The colorant of any examples herein, particularly examples 10-41, wherein R⁴ is OH or O-glucoside.

Example 43: The colorant of any examples herein, particularly examples 10-42, wherein R⁶ is OH, O-rutinoside, or O-(p-coumaroyl-rutinoside).

Example 44: The colorant of any examples herein, particularly examples 10-43, wherein R⁴ and R⁶ are both OH.

Example 45: The colorant of any examples herein, particularly examples 10-43, wherein R⁴ is OH and R⁶ is O-rutinoside.

Example 46: The colorant of any examples herein, particularly examples 10-43, wherein R⁴ is O-glucoside and R⁶ is O-(p-coumaroyl-rutinoside).

Example 47: The colorant of any examples herein, particularly examples 1-46, wherein the anthocyanidin, the anthocyanin, or a combination thereof comprises a cyanidin, a delphindin, a petunidin, or a combination thereof.

Example 48: The colorant of any examples herein, particularly examples 1-47, wherein the anthocyanidin, the anthocyanin, or a combination thereof comprises delphinidin-3-glucoside, delphinidin-3-rutinoside, delphinidin-3-(p-coumaroylrutinoside)-5-glucoside, petunidin-3-(p-coumaroylrutinoside)-5-glucoside, or a combination thereof.

Example 49: The colorant of any examples herein, particularly examples 1-48, wherein the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof.

Example 50: The colorant of any examples herein, particularly examples 1-49, wherein the caffeoylquinic acid is of Formula III:

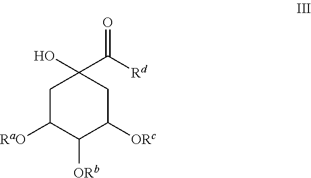

wherein
R^{d} is OH, OC₁₋₄alkyl, or forms bond with one of R^{a}, R^{b}, or R^{C};
R^{a} is H, forms a bond with R^{d}, or has the formula:

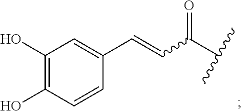 [SMILES: *C(=O)C=Cc1ccc(O)c(O)c1]

R^{b} is H, forms a bond with R^{d}, or has the formula:

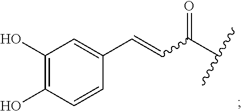 [SMILES: *C(=O)C=Cc1ccc(O)c(O)c1]

R^{c} is H, forms a bond with R^{d}, or has the formula:

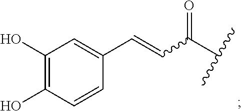 [SMILES: *C(=O)C=Cc1ccc(O)c(O)c1]

provided that at least one of R^{a}, R^{b}, or R^{C} has the formula:

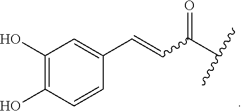 [SMILES: *C(=O)C=Cc1ccc(O)c(O)c1]

Example 51: The colorant of any examples herein, particularly example 50, wherein R^{a} has the formula:

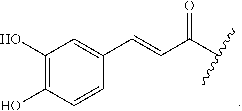 [SMILES: *C(=O)/C=C/c1ccc(O)c(O)c1]

Example 52: The colorant of any examples herein, particularly example 50 or example 51, wherein R^{b} has the formula:

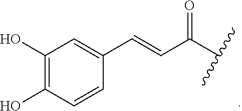 [SMILES: *C(=O)/C=C/c1ccc(O)c(O)c1]

Example 53: The colorant of any examples herein, particularly examples 50-52, wherein R^{c} has the formula:

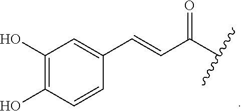 [SMILES: *C(=O)/C=C/c1ccc(O)c(O)c1]

Example 54: The colorant of any examples herein, particularly example 50 or example 51, wherein R^{b} and R^{c} are each H.

Example 55: The colorant of any examples herein, particularly examples 50-54, wherein the caffeoylquinic acid is of Formula III-A:

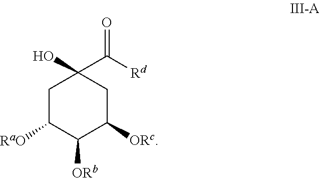

Example 56: The colorant of any examples herein, particularly examples 1-55, wherein the caffeoylquinic acid comprises 5-caffeoylquinic acid, 4-caffeoylquinic acid, 3-caffeoylquinic acid, or a combination thereof.

Example 57: The colorant of any examples herein, particularly examples 1-56, wherein the caffeoylquinic acid comprises 5-caffeoylquinic acid.

Example 58: The colorant of any examples herein, particularly examples 1-57, wherein: the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof; and the caffeoylquinic acid comprises 5-caffeoylquinic acid.

Example 59: The colorant of any examples herein, particularly examples 1-58, wherein: the caffeoylquinic acid comprises 5-caffeoylquinic acid; and the aluminum salt comprises AlCl₃, Al₂(SO₄)₃, or a combination thereof.

Example 60: The colorant of any examples herein, particularly examples 1-59, wherein: the anthocyanidin, the anthocyanin, or a combination thereof comprises delphinidin-3-rutinoside delphinidin-3-(p-coumaroylrutinoside)-5-glucoside, petunidin-3-(p-coumaroylrutinoside)-5-glucoside, or a combination thereof; the caffeoylquinic acid comprises 5-caffeoylquinic acid; and the aluminum salt comprises AlCl₃, Al₂(SO₄)₃, or a combination thereof.

Example 61: The colorant of any examples herein, particularly examples 1-60, wherein the colorant is edible.

Example 62: The colorant of any examples herein, particularly examples 1-61, wherein the composition is at least partially derived from an edible material.

Example 63: The colorant of any examples herein, particularly examples 1-62, wherein the aluminum salt is food safe.

Example 64: The colorant of any examples herein, particularly examples 1-63, wherein the anthocyanidin, the anthocyanin, or combination thereof is an extract of an edible material.

Example 65: The colorant of any examples herein, particularly examples 1-64, wherein the anthocyanidin, the anthocyanin, or combination thereof is an extracted of an eggplant (e.g., American eggplant, Asian eggplant), black goji, or a combination thereof.

Example 66: The colorant of any examples herein, particularly examples 1-65, wherein the anthocyanidin, the anthocyanin, or combination thereof is an extract of an eggplant.

Example 67: The colorant of any examples herein, particularly examples 1-66, wherein the caffeoylquinic acid is an extract from an edible material.

Example 68: The colorant of any examples herein, particularly examples 1-67, wherein the caffeoylquinic acid is an extract from Yerba Mate.

Example 69: The colorant of any examples herein, particularly examples 1-68, wherein the anthocyanidin, the anthocyanin, or combination thereof is an extract of a first edible material and the caffeoylquinic acid is an extract of a second edible material.

Example 70: The colorant of any examples herein, particularly examples 1-69, wherein the anthocyanidin, the anthocyanin, or combination thereof is an extract of an eggplant, black goji, or a combination thereof; and the caffeoylquinic acid is an extract of Yerba Mate.

Example 71: The colorant of any examples herein, particularly examples 1-70, wherein the anthocyanidin, the anthocyanin, or combination thereof is an extract of an eggplant; and the caffeoylquinic acid is an extract of Yerba Mate.

Example 72: The colorant of any examples herein, particularly examples 1-71, wherein the colorant has a vibrant and stable blue color at pH from 2.9 to 5.

Example 73: The colorant of any examples herein, particularly examples 1-72, wherein the colorant has a vibrant and stable blue color at pH from 2.9 to 3.3.

Example 74: The colorant of any examples herein, particularly examples 1-73, wherein the colorant has a vibrant and stable blue color at pH from 3.3 to 4.

Example 75: The colorant of any examples herein, particularly examples 1-74, wherein the colorant has a vibrant and stable blue color at pH 3.3.

Example 76: The colorant of any examples herein, particularly examples 1-75, wherein the colorant has a vibrant and stable blue color at pH 4.

Example 77: The colorant of any examples herein, particularly examples 1-76, wherein the colorant has a vibrant blue color that is stable for an amount of time of 2 months or more at pH 2.9 to 5 and a temperature of 4° C.

Example 78: The colorant of any examples herein, particularly examples 1-77, wherein the colorant forms a complex similar to the Hydrangea Blue-complex.

Example 79: The colorant of any examples herein, particularly examples 1-78, wherein the colorant comprises a complex of Formula IV:

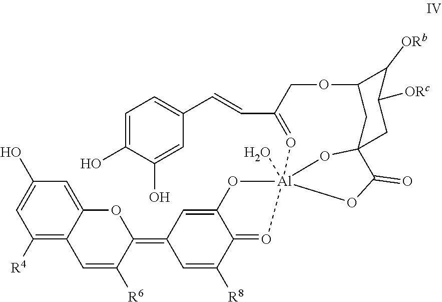

wherein
R⁴ is OR^{S};
R⁶ is OR^{S};
R⁸ is H, OH, or OCH₃;
R^{S} in each case independently has the formula:

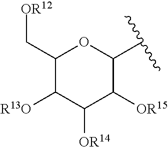

wherein
R¹² is H or monosaccharide;
R¹³ is H or monosaccharide;
R¹⁴ is H or monosaccharide; and
R¹⁵ is H or monosaccharide;
and wherein
R^{b} is H or has the formula:

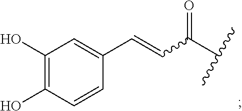 [SMILES: *C(=O)C=Cc1ccc(O)c(O)c1]

R^{c} is H or has the formula:

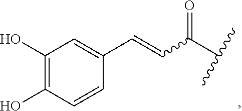 [SMILES: *C(=O)C=Cc1ccc(O)c(O)c1]

or a salt or derivative thereof.

Example 80: The colorant of any examples herein, particularly example 79, wherein the colorant comprises of Formula IV-A:

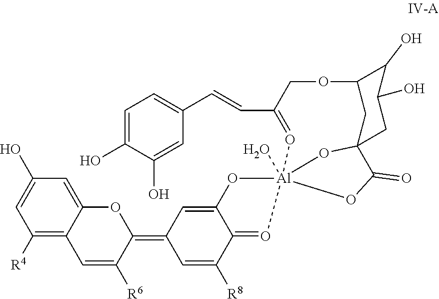

or a salt or derivative thereof.

Example 81: The colorant of any examples herein, particularly examples 1-79, wherein the colorant comprises a complex of Formula V:

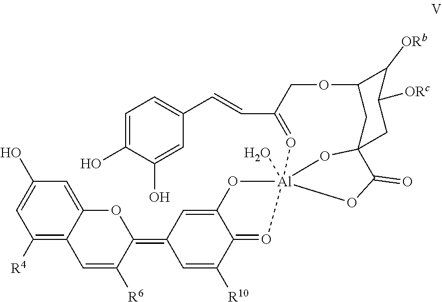

wherein
R⁴ is OR^{S};
R⁶ is OR^{S}; and
R¹⁰ is H, or OH;
R^{S} in each case independently has the formula:

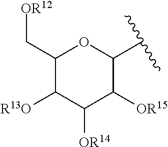

wherein
R¹² is H or monosaccharide;
R¹³ is H or monosaccharide;
R¹⁴ is H or monosaccharide; and
R¹⁵ is H or monosaccharide;
and wherein
R^{b} is H or has the formula:

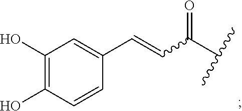 [SMILES: *C(=O)C=Cc1ccc(O)c(O)c1]

R^{c} is H or has the formula:

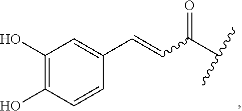 [SMILES: *C(=O)C=Cc1ccc(O)c(O)c1]

or a salt or derivative thereof.

Example 82: The colorant of any examples herein, particularly example 81, wherein the colorant comprises a complex of Formula V-A:

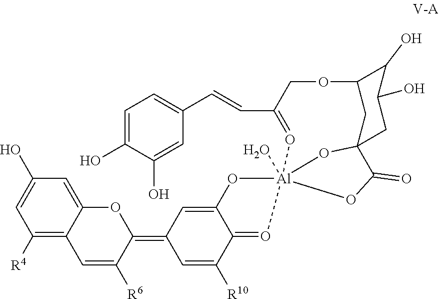

or a salt or derivative thereof.

Example 83: The colorant of any examples herein, particularly examples 1-79, wherein the colorant comprises a complex of Formula VI:

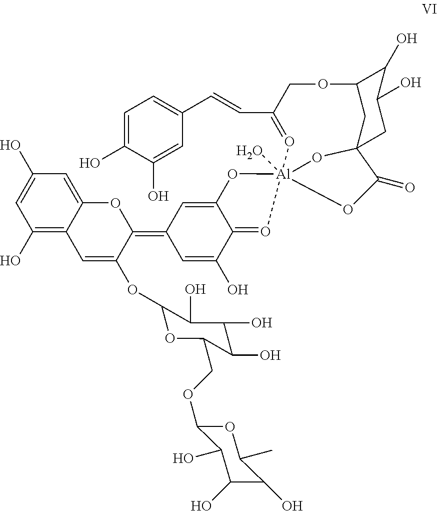

or a salt or derivative thereof.

Example 84: A colorant composition, comprising the extract of an eggplant, the extract of Yerba Mate, and an aluminum salt.

Example 85: The colorant according to any examples herein, particularly example 84, wherein the extract of an eggplant is the extract of an eggplant peel.

Example 86: The colorant of any examples herein, particularly example 84 or example 85, wherein the extract of an eggplant is a methanol extract.

Example 87: The colorant of any examples herein, particularly examples 84-86, wherein the extract of an eggplant is an acidic methanol extract.

Example 88: The colorant of any examples herein, particularly examples 84-87, wherein the Yerba Mate extract is a hot water extract.

Example 89: The colorant of any examples herein, particularly examples 84-88, wherein the colorant comprises the colorant composition of any examples herein, particularly examples 1-83.

Example 90: A beverage comprising the colorant of any examples herein, particularly examples 1-89.

Example 91: A food product comprising the colorant of any examples herein, particularly examples 1-89.

Example 92: An edible product comprising the colorant of any examples herein, particularly examples 1-89.

Example 93: A method of making the colorant composition of any examples herein, particularly examples 1-89.

Example 94: The method of any examples herein, particularly example 93, wherein the method comprises contacting, in any order, the aluminum salt; the anthocyanidin, the anthocyanin, or a combination thereof; and the caffeoylquinic acid; optionally in the presence of a solvent; wherein the method is performed at a pH of 4, to thereby form the colorant composition.

Example 95: The method of any examples herein, particularly example 94, wherein the method further comprises subsequently adjusting the pH above or below 4, for example such that the pH is from 2.9 to less than 4 or wherein the pH is from greater than 4 to 5.

Example 96: The method of any examples herein, particularly example 94 or example 95, wherein the method further comprises extracting the anthocyanidin, the anthocyanin, or a combination thereof from an edible material.

Example 97: The method of any examples herein, particularly example 96, wherein the anthocyanidin, the anthocyanin, or combination thereof is extracted from an eggplant (e.g., American eggplant, Asian eggplant), black goji, or a combination thereof.

Example 98: The method of any examples herein, particularly example 96 or example 97, wherein the anthocyanidin, the anthocyanin, or combination thereof is extracted from an eggplant.

Example 99: The method of any examples herein, particularly examples 93-98, wherein the method further comprises extracting the caffeoylquinic acid from an edible material.

Example 100: The method of any examples herein, particularly example 99, wherein the caffeoylquinic acid is extracted from Yerba Mate.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A colorant composition comprising:
a) an aluminum salt;
b) an anthocyanidin, an anthocyanin, or a combination thereof; and
c) a caffeoylquinic acid;
wherein:
the colorant is blue at pH 2.9 to 3.3;
the colorant is edible;
at least a portion of the composition is an extract of an edible material;
or a combination thereof.

2. (canceled)

3. (canceled)

4. (canceled)

5. The colorant of claim 1, wherein the composition is an aqueous composition having a pH from 2.9 to 5.

6. The colorant of claim 1, wherein the aluminum salt is an Al³⁺ salt.

7. The colorant of claim 1, wherein the aluminum salt is AlCl₃, Al₂(SO₄)₃, aluminum hydroxide, aluminum oleate, aluminum palmitate, aluminum ammonium sulfate, aluminum potassium sulfate, aluminum sodium sulfate, sodium aluminum phosphate, aluminum calcium silicate, sodium aluminosilicate, or a combination thereof.

8. (canceled)

9. (canceled)

10. The colorant of claim 1, wherein the anthocyanidin or anthocyanin is of Formula I: 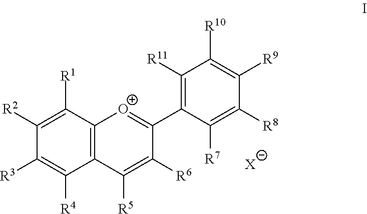
wherein
X is an acceptable anion (e.g., chloride, bromide, iodide, nitrate, sulfate, hydrogen sulfate, phosphate, hydrogen phosphate, dihydrogen phosphate, acetate, etc.);
R¹ is H, OH, OCH₃, or OR^{S};
R² is H, OH, OCH₃, or OR^{S};
R³ is H, OH, OCH₃, or OR^{S};
R⁴ is H, OH, OCH₃, or OR^{S};
R⁵ is H, OH, OCH₃, or OR^{S};
R⁶ is H, OH, OCH₃, or OR^{S};
R⁷ is H, OH, OCH₃, or OR^{S};
R⁸ is H, OH, OCH₃, or OR^{S};
R⁹ is H, OH, OCH₃, or OR^{S};
R¹⁰ is H, OH, OCH₃, or OR^{S};
R¹¹ is H, OH, OCH₃, or OR^{S}; and
each R^{S} independently is a sugar, an acid, or a combination thereof.

11. (canceled)

12. The colorant of claim 10, wherein R^{S} is in each case independently has the formula: 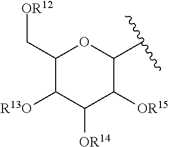
wherein
R¹² is H or monosaccharide;
R¹³ is H or monosaccharide;
R¹⁴ is H or monosaccharide; and
R¹⁵ is H or monosaccharide.

13.-31. (canceled)

32. The colorant of claim 1, wherein the anthocyanidin or anthocyanin is of Formula II: 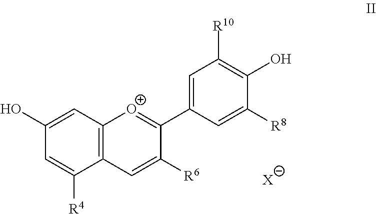
wherein
R⁴ is OR^{S};
R⁶ is OR^{S};
R⁸ is H, OH, or OCH₃; and
R¹⁰ is H, or OH;
R^{S} in each case independently has the formula: 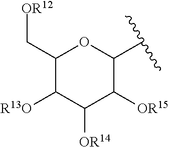
wherein
R¹² is H or monosaccharide;
R¹³ is H or monosaccharide;
R¹⁴ is H or monosaccharide; and
R¹⁵ is H or monosaccharide.

33.-46. (canceled)

47. The colorant of claim 1, wherein the anthocyanidin, the anthocyanin, or a combination thereof comprises a cyanidin, a delphindin, a petunidin, or a combination thereof.

48. The colorant of claim 1, wherein the anthocyanidin, the anthocyanin, or a combination thereof comprises delphinidin-3-glucoside, delphinidin-3-rutinoside, delphinidin-3-(p-coumaroylrutinoside)-5-glucoside, petunidin-3-(p-coumaroylrutinoside)-5-glucoside, or a combination thereof.

49. (canceled)

50. The colorant of claim 1, wherein the caffeoylquinic acid is of Formula III: 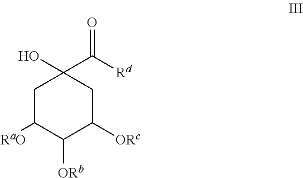
wherein
R^{d} is OH, OC₁₋₄alkyl, or forms bond with one of R^{a}, R^{b}, or R^{C};
R^{a} is H, forms a bond with R^{d}, or has the formula: 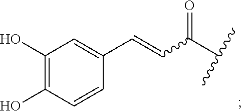 [SMILES: *C(=O)C=Cc1ccc(O)c(O)c1]
R^{b} is H, forms a bond with R^{d}, or has the formula: 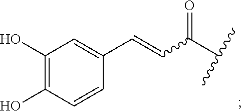 [SMILES: *C(=O)C=Cc1ccc(O)c(O)c1]
R^{c} is H, forms a bond with R^{d}, or has the formula: 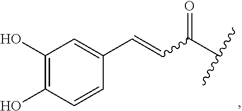 [SMILES: *C(=O)C=Cc1ccc(O)c(O)c1]
provided that at least one of R^{a}, R^{b}, or R^{c} has the formula:

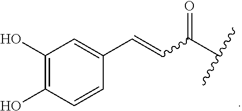 [SMILES: *C(=O)C=Cc1ccc(O)c(O)c1]

51.-55. (canceled)

56. The colorant of claim 1, wherein the caffeoylquinic acid comprises 5-caffeoylquinic acid, 4-caffeoylquinic acid, 3-caffeoylquinic acid, or a combination thereof.

57.-60. (canceled)

61. The colorant of claim 1, wherein the colorant is edible.

62. (canceled)

63. The colorant of claim 1, wherein the aluminum salt is food safe.

64.-68. (canceled)

69. The colorant of claim 1, wherein the anthocyanidin, the anthocyanin, or combination thereof is an extract of a first edible material and the caffeoylquinic acid is an extract of a second edible material.

70. The colorant of claim 1, wherein the anthocyanidin, the anthocyanin, or combination thereof is an extract of an eggplant, black goji, or a combination thereof; and the caffeoylquinic acid is an extract of Yerba Mate.

71. (canceled)

72. The colorant of claim 1, wherein the colorant has a vibrant and stable blue color at pH from 2.9 to 5.

73.-78. (canceled)

79. The colorant of claim 1, wherein the colorant comprises a complex of Formula IV: 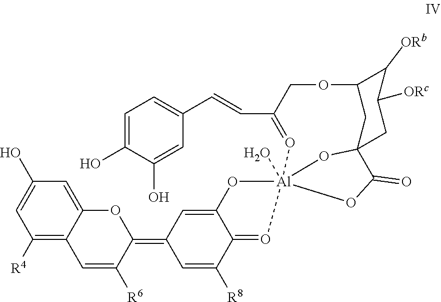
wherein
R⁴ is OR^{S};
R⁶ is OR^{S};
R⁸ is H, OH, or OCH₃;
R^{S} in each case independently has the formula: 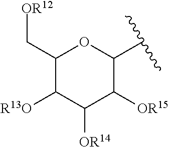
wherein
R¹² is H or monosaccharide;
R¹³ is H or monosaccharide;
R¹⁴ is H or monosaccharide; and
R¹⁵ is H or monosaccharide;
and wherein
R^{b} is H or has the formula: 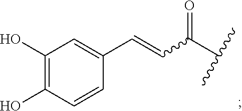 [SMILES: *C(=O)C=Cc1ccc(O)c(O)c1]
R^{c} is H or has the formula: 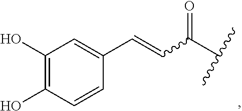 [SMILES: *C(=O)C=Cc1ccc(O)c(O)c1]
or a salt or derivative thereof.

80. (canceled)

81. (canceled)

82. (canceled)

83. The colorant of claim 1, wherein the colorant comprises a complex of Formula VI: 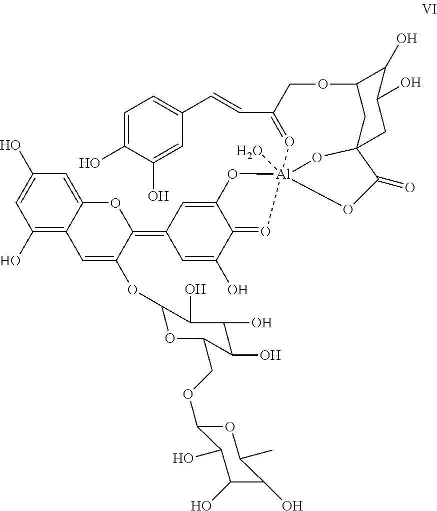
or a salt or derivative thereof.

84. A colorant composition, comprising the extract of an eggplant, the extract of Yerba Mate, and an aluminum salt.

85.-89. (canceled)

90. A beverage, food product, edible product, or combination thereof comprising the colorant of claim 1.

91.-100. (canceled)
